(19) United States
(12) Patent Application Publication
(10) Pub. No.: US 2025/0094947 A1
(43) Pub. Date: Mar. 20, 2025

(54) COMPUTATIONAL PROCESSING BASED ON SELECTED CRITERIA

(71) Applicant: PayPal, Inc., San Jose, CA (US)

(72) Inventor: Sujay Vijay Purandare, Austin, TX (US)

(21) Appl. No.: 18/581,877

(22) Filed: Feb. 20, 2024

Related U.S. Application Data
(60) Provisional application No. 63/583,003, filed on Sep. 15, 2023.

(51) Int. Cl. G06Q 20/10; G06Q 20/06; G06Q 20/38

(52) U.S. Cl. CPC G06Q 20/102; G06Q 20/065; G06Q 20/3827; G06Q 20/3829; G06Q 20/389

(57) ABSTRACT

Networked computer nodes may collectively compete to process one more specific computing operations. A framework for selectively targeting a group of computer nodes as eligible to process the one or more computing operations is disclosed. A subset of computer nodes may be selected as targeted computer nodes for processing the computing operation based on a set of criteria. The one or more computing operations may include cryptographic operations.

### CROSS REFERENCE TO RELATED APPLICATION

The present application claims priority to U.S. Provisional Patent Application Ser. No. 63/583,003, filed Sep. 15, 2023, which is incorporated herein by reference in its entirety.

### BACKGROUND

The present specification generally relates to computer frameworks, and more specifically, to providing a computer framework capable of selectively targeting a subset of computer nodes as eligible to process one or more particular computing operations that include cryptographic operations according to various embodiments of the disclosure.

### RELATED ART

Due to the complexity of certain required computations, a substantial amount of computer resources, and consequently a substantial amount of power, is consumed by each computer node in computer framework that participates in the competition for recording a cryptocurrency transaction. To alleviate this problem, blockchain participants may attempt to create and use computer algorithms that enable their computer nodes to perform one or more specific computations more efficiently (e.g., using less computer power, using less computer memory, etc.) or by using power generated by environmentally friendly sources (e.g., solar power, wind power, etc.). Parties involved in a cryptocurrency transaction may wish to have their cryptocurrency transaction processed by the computer nodes that satisfy certain criteria (e.g., more efficient and/or more environmentally friendly when processing the transactions, etc.).

However, under various current schemes, there is no computer-based mechanism for the parties involved in a cryptocurrency transaction to specify one or more computer nodes for (or excluding one or more computer nodes from) recording the cryptocurrency transaction, as any computer node associated with the cryptocurrency may be eligible to compete for the right to record the cryptocurrency transaction.

As a result, computing resources may be unnecessarily used if computer nodes that are not configured efficiently end up participating in the processing of transactions. Thus, Applicant recognizes there is a need for providing a framework for selectively targeting a subset of computer nodes for processing cryptocurrency transactions in order to reduce computer power and memory usage according to various embodiments.

### BRIEF DESCRIPTION OF THE FIGURES

FIG. 1 is a block diagram illustrating a networked system that includes an electronic transaction system according to an embodiment of the present disclosure;

FIG. 2A illustrates an example blockchain network according to an embodiment of the present disclosure;

FIG. 2B illustrates an example Layer Two cryptocurrency computer network according to an embodiment of the present disclosure;

FIG. 3A illustrates an example blockchain according to an embodiment of the present disclosure;

FIG. 3B illustrates an example electronic token according to an embodiment of the present disclosure;

FIG. 4 illustrates an example ledger according to an embodiment of the present disclosure;

FIG. 5 illustrates an example transaction record for selectively targeting of computer nodes according to an embodiment of the present disclosure;

FIG. 6 illustrates an example transaction block generated for redeeming a secondary transaction fee according to an embodiment of the present disclosure;

FIG. 7 is a flowchart showing a process of generating a transaction record that targets certain computer nodes according to an embodiment of the present disclosure;

FIG. 8 is a flowchart showing a process of generating a transaction block for redeeming a secondary transaction fee according to an embodiment of the present disclosure;

FIG. 9 is a flowchart showing a process of transferring a secondary transaction fee via a Layer Two cryptocurrency computer network according to an embodiment of the present disclosure; and

FIG. 10 is a block diagram of a system for implementing a device according to an embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure includes methods and systems for providing a framework that enables selectively targeting a subset of computer nodes for processing a cryptocurrency transaction. As discussed herein, under some cryptocurrency schemes, all of the computer nodes that are associated with a cryptocurrency are eligible to compete for the right of recording a cryptocurrency transaction. Note: while various examples and embodiments are described herein relative to a “cryptocurrency transaction”, the techniques herein may be used more broadly for any type of blockchain transaction, according to various embodiments. Thus, while the term “cryptocurrency” may be used for ease of explanation, it should be understood that the present improvements apply to “blockchain” transactions and management, more generally.

In such schemes, a single computer node that is selected to record a cryptocurrency transaction (e.g., the computer node that wins against other participating computer nodes in the performance of a series of computations, etc.) may earn a transaction fee in exchange for the work in processing and recording the cryptocurrency transaction on the ledger (e.g., a blockchain). There is currently no sufficiently suitable computer-based mechanism for excluding certain computer nodes from participating in the transaction recording process. Thus, the parties involved in a cryptocurrency transaction (e.g., a sender of funds, a recipient of the funds, a payment processing server, etc.) have little or no control over which computer node(s) to use for processing the cryptocurrency transaction.

According to various embodiments of the disclosure, a framework for a computer-based protocol is provided, where the framework may be implemented by a cryptocurrency transaction server and computer nodes within a blockchain network associated with a cryptocurrency for selectively targeting a subset of the computer nodes, but not all of the computer nodes, for processing cryptocurrency transactions. The computer-based protocol enables a targeted computer node, but not a non-targeted computer node, that processes a cryptocurrency transaction in a Layer One cryptocurrency computer network to collect a secondary transaction fee (in addition to the transaction fee indicated in a cryptocurrency transaction) via a Layer Two cryptocurrency computer network in exchange for processing the cryptocurrency transaction.

The Layer Two cryptocurrency computer network is a separate computer network from the Layer One cryptocurrency computer network. A computer node may participate in the Layer Two cryptocurrency computer network by establishing a payment channel (or a token exchange channel) with another computer node. At least one of the two participating computer nodes may contribute funds (in cryptocurrency) to the payment channel to prove its liquidity for transacting within the Layer Two cryptocurrency computer network. The payment channel further includes a multi-signature agreement recorded in the Layer One cryptocurrency computer network. The multi-signature agreement specifies that any transaction using funds that have been contributed to the payment channel in the Layer One cryptocurrency computer network require digital signatures from the two parties (e.g., the two computer nodes) associated with the payment channel. As such, the multi-signature agreement ensures that the funds that have been contributed to the payment channel cannot be accessed/spent by any one of the parties unilaterally without approval from both parties.

Once a payment channel is established between the two computer nodes, the two computer nodes can perform cryptocurrency transactions (transferring funds between the two computer nodes) outside of the Layer One cryptocurrency computer network (e.g., off-chain transactions). Initially, each of the two computer nodes is assigned with the amount of cryptocurrency that the computer node contributed in the payment channel. Each transaction from a computer node may use at least a portion of the funds assigned to the computer node in the payment channel, as long as the total transaction amount including all previous Layer Two transactions by the computer node does not exceed the amount assigned to the computer node. Each transaction is conducted by issuing a new agreement between the two computer nodes for reassigning (e.g., reallocating) the funds within the payment channel based on the amount in the transaction and the previous assignment of the funds, without recording the transaction within the Layer One cryptocurrency computer network. The new agreement would supersede any previous agreement between the two computer nodes. As such, no computer resources associated with the proof of work or proof of stake requirements (that are required when conducting transactions via the Layer One cryptocurrency computer network) are consumed throughout the cryptocurrency transaction. Only when a payment channel is terminated would a transaction for settling the funds allocation between the two computer nodes need to be recorded in the Layer One cryptocurrency computer network. Thus, transactions conducted via the Layer Two cryptocurrency computer network require less computer resources and less time than the same transactions conducted via the Layer One cryptocurrency computer network.

The two computer nodes may in turn establish additional payment channels with other computer nodes in a similar manner to further extend the Layer Two cryptocurrency computer network. Thus, after multiple payment channels are established among the computer nodes within the Layer Two cryptocurrency computer network, one computer node may conduct Layer Two cryptocurrency transactions with another computer node as long as the two computer nodes are connected via one or more payment channels (even though no payment channel is established between the two computer nodes).

In some embodiments, the cryptocurrency transaction server and the computer nodes of the blockchain network (Layer One cryptocurrency computer network) are connected with each other via a Layer Two cryptocurrency computer network or have access to the Layer Two cryptocurrency computer network such that funds in cryptocurrency (e.g., the secondary transaction fee) can be transferred between the cryptocurrency transaction server and the computer nodes via the Layer Two cryptocurrency computer network.

In some embodiments, the cryptocurrency transaction server may correspond to a cryptocurrency transaction platform configured to facilitate cryptocurrency transactions (e.g., transferring funds in the cryptocurrency among digital wallets of different users, facilitating a purchase of an item or a service using funds in the cryptocurrency, etc.) for its users. As such, the cryptocurrency transaction server may be communicatively coupled with one or more of the computer nodes of a blockchain network associated with the cryptocurrency. In some embodiments, the cryptocurrency transaction server may provide a user interface (e.g., a web interface, a mobile application interface, etc.) that enables its users to initiate a cryptocurrency transaction through the cryptocurrency transaction server (e.g., submitting a request for processing the cryptocurrency transaction). The cryptocurrency transaction server may generate a transaction record for the cryptocurrency transaction, and may broadcast the transaction record to one or more computer nodes within the blockchain network for processing the cryptocurrency transaction.

In some embodiments, the cryptocurrency transaction server may determine transaction information associated with a cryptocurrency transaction based on inputs provided by a user via a user interface. The transaction information may include identities of the parties (e.g., addresses associated with digital wallets of the sender and the recipient, etc.) involved in the cryptocurrency transaction, a transaction amount associated with the cryptocurrency transaction, a transaction fee amount to be paid to the computer node selected for processing the cryptocurrency transaction, and a set of criteria for selecting a subset of computer nodes to be targeted for processing the cryptocurrency transaction.

As such, a user may specify, via the user interface provided by the cryptocurrency transaction server, identities of the parties involved in a cryptocurrency transaction (e.g., a sender digital wallet address, a receiver digital wallet address, etc.), an amount in the cryptocurrency to be transferred, and a transaction fee amount to be paid to the computer node that processes the cryptocurrency transaction. In some embodiments, the cryptocurrency transaction server may determine a set of criteria for selecting a subset of computer nodes to be targeted for processing the cryptocurrency transaction, for example, based on the identities of the parties and/or the transaction amount, or any other factors. In some embodiments, the user may also specify, via the user interface, the set of criteria for selecting a subset of computer nodes to be targeted for processing the cryptocurrency transaction. The set of criteria may be associated with attributes of the computer nodes (e.g., a processor type of the computer node, an amount of memory in the computer node, a location of the computer node, etc.), efficiency characteristics associated with processing a cryptocurrency transaction (e.g., a power consumption required for processing a cryptocurrency transaction, a computer memory usage required for processing a cryptocurrency transaction, etc.), attributes associated with a power source used for processing a cryptocurrency transaction (e.g., a ratio of “clean” vs. “dirty” power source, etc.), or any other types of criteria that are related to the computer nodes. As used herein, a “clean” power source may refer to power sources associated with a renewable energy source such as solar, wind, hydro, etc., and a “dirty” power source may refer to power sources associated with a traditional (non-renewable) energy source such as coal, natural gas, etc.

In some embodiments, the cryptocurrency transaction server may obtain characteristics of the computer nodes within the blockchain network associated with the cryptocurrency. For example, the cryptocurrency transaction server may communicate with the computer nodes and/or monitor the computer nodes as the computer nodes process one or more cryptocurrency transactions. In some embodiments, the cryptocurrency transaction server may transmit programming code to the computer nodes, which will be executed by each of the computer nodes. Based on executing the programming code, each of the computer nodes may determine various attributes associated with itself (e.g., a location of the computer node, a processor type of the computer node, a memory capacity of the computer node, etc.). In some embodiments, based on executing the programming code, each of the computer nodes may monitor characteristics of itself (e.g., a power usage, a computer memory usage, etc.) as each of the computer nodes processes a cryptocurrency transaction. In some embodiments, based on executing the programming code, each of the computer nodes may access power source information (e.g., power source of the computer node, such as solar, wind, coal, etc.). The computer nodes may then transmit the information, including power source information, back to the cryptocurrency transaction server.

Based on the information retrieved from the computer nodes, the cryptocurrency transaction server may generate a metric (e.g., a processor usage metric, a power source metric, a memory usage metric, etc.) for evaluating each of the computer nodes. The cryptocurrency transaction server may then select, from the computer nodes within the blockchain network associated with the cryptocurrency, a subset of computer nodes that satisfy the set of criteria. For example, when the set of criteria is associated with a ratio between a clean power source and a dirty power source, the cryptocurrency transaction server may select computer nodes that operate on power sources having a ratio of clean power use or consumption to dirty power use or consumption exceeding a threshold ratio. When the set of criteria is associated with a computer configuration (e.g., a processor type, a computer memory type or capacity, an operating system, etc.), the cryptocurrency transaction server may select computer nodes with attributes that satisfy the computer configuration. When the set of criteria is associated with a geographical location, the cryptocurrency transaction server may select computer nodes that are located within the geographical location (or located outside of the geographical location).

In some embodiments, once the subset of computer nodes (also referred to as “targeted computer nodes”) that satisfy the set of criteria is selected, the cryptocurrency transaction server may communicate with the targeted computer nodes and may perform a computer-based handshake with the targeted computer nodes as part of a computer-based protocol of the framework for targeting the subset of computer nodes in association with one or more subsequent cryptocurrency transactions. The computer-based handshake may include the cryptocurrency transaction server generating (or otherwise determining) an indicator (e.g., a code) that can be included in a transaction record for indicating that the transaction record is generated to target the targeted computer nodes. For example, the code may include an identifier associated with the cryptocurrency transaction server (e.g., an address associated with a digital wallet of the cryptocurrency transaction server) and/or an arbitrarily (e.g., randomly) generated code (e.g., an alphanumeric code, an image code, etc.).

In addition, the computer-based handshake may also include the cryptocurrency transaction server generating pairs of asymmetrical encryption keys for the targeted computer nodes. The encryption keys will be used by the cryptocurrency transaction server for verifying the identity of the computer node that processes the one or more subsequent cryptocurrency transactions such that the secondary transaction fee is transferred via the Layer Two cryptocurrency computer network to the targeted computer node that processed the cryptocurrency transaction. For example, the cryptocurrency transaction server may generate a pair of corresponding encryption keys (e.g., a private encryption key and a public encryption key) for each targeted computer node, and may distribute one of the corresponding encryption keys (e.g., the public encryption key), but not the other one of the corresponding encryption keys (e.g., the private encryption key), to the targeted computer node. In some embodiments, each targeted computer node may use the corresponding public key to encrypt a digital invoice corresponding to the secondary transaction fee, and record the digital invoice in a transaction block for redeeming the secondary transaction fee. Based on the encrypted digital invoice that is recorded on the blockchain, the cryptocurrency transaction server may identify the targeted computer node that processes a cryptocurrency transaction and may transfer the corresponding secondary transaction fee to the computer node via the Layer Two cryptocurrency computer network.

In some embodiments, based on the transaction data received from the user via the user interface, the cryptocurrency transaction server may generate a transaction record for the cryptocurrency transaction. The transaction record may be generated in a format corresponding to the specification and/or the protocol associated with the cryptocurrency (e.g., a Bitcoin transaction format, a Litecoin transaction format, an Ethereum transaction format, etc.). The transaction record may include one or more fields according to the transaction format, such as a transaction identifier that uniquely identifies the transaction record within the blockchain network (e.g., which can be generated by performing a hash function to the transaction data), one or more transaction inputs that specify one or more sources of the funds involved in the cryptocurrency transaction, and one or more transaction outputs (also referred to as “UTXOs”) that specify one or more recipients of the corresponding funds from the one or more transaction inputs.

The cryptocurrency transaction server may generate a transaction record for the cryptocurrency transaction based on the data provided by the user via the user interface. The transaction record may include a first transaction input/output pair, including: a first transaction input specifying unspent funds that the sender digital wallet received in a previous cryptocurrency transaction recorded on the blockchain and corresponding to the transaction amount, and a first transaction output that specifies the address associated with the recipient digital wallet. The transaction record may also specify a transaction fee to be paid to the computer node selected to process the cryptocurrency transaction (e.g., recording the transaction record on a blockchain associated with the cryptocurrency).

In some embodiments, in order to target the subset of the computer nodes for processing the cryptocurrency transaction, instead of specifying the transaction fee amount indicated by the user, the cryptocurrency transaction server may specify a zero transaction fee or a nominal transaction fee (e.g., a minimum transaction fee amount allowed for the cryptocurrency, etc.). Such a low (or zero) transaction fee amount may disincentivize non-targeted computer nodes from participating in the processing of the cryptocurrency transaction. On the other hand, to incentivize the targeted computer nodes to participate in the processing of the cryptocurrency transaction, the cryptocurrency transaction server may provide, in the transaction record, an indication that an additional non-nominal transaction fee (e.g., a secondary transaction fee) is available to a targeted computer node that processes the cryptocurrency transaction.

For example, the cryptocurrency transaction server may insert a second transaction input/output pair into the transaction record. The second transaction input/output pair may include a second transaction input specifying additional unspent funds. In some embodiments, the unspent funds specified in the second transaction input may correspond to the actual transaction fee indicated by the user for the cryptocurrency transaction. The second transaction input/output pair may also include a second transaction output that includes the code that was negotiated during the computer-based handshake between the cryptocurrency transaction server and targeted computer nodes. For example, the code may include an identifier of the cryptocurrency transaction server, such as an address of a digital wallet associated with the cryptocurrency transaction server. In another example, the code may include an alphanumeric code (or other types of machine-readable code) that is determined by the cryptocurrency transaction server. The second transaction output may also indicate a digital wallet of the cryptocurrency transaction server as the recipient of the unspent funds indicated in the second transaction input. Thus, when the transaction record is processed (e.g., recorded on the blockchain, etc.), the cryptocurrency transaction server may access and use (e.g., spend) the funds associated with the secondary transaction fee. In some embodiments, after the transaction record is processed (e.g., recorded on the blockchain), the cryptocurrency transaction server may use the funds received via the second transaction input/output pairs to pay a targeted computer node via the Layer Two cryptocurrency computer network. After generating the transaction record, the cryptocurrency transaction server may broadcast the transaction record to the computer nodes of the blockchain network (e.g., the Layer One cryptocurrency computer network) associated with the cryptocurrency.

Each of the computer nodes that receive the transaction record may inspect and analyze the transaction record before determining whether to participate in the processing of the transaction record. When a computer node that is not part of the subset of computer nodes (also referred to as “a non-targeted node”) receives the transaction record, the non-targeted computer node is more likely to determine not to participate in the processing of the cryptocurrency transaction, as the low (or zero) transaction fee would not justify the cost for processing the cryptocurrency transaction by the computer nodes. However, when a computer node that is part of the subset of computer nodes (also referred to as “a targeted computer node”) receives the transaction record, the targeted computer node may determine that a secondary transaction fee is available to the targeted computer node based on the indicator included in the second transaction input/output pair. As such, the targeted computer node is incentivized to participate in the processing of the cryptocurrency transaction based on the secondary transaction fee amount indicated in the second transaction input/output pair of the transaction record, which is not available to computer nodes outside of the subset of computer nodes.

Based on performing the specified computations, a targeted computer node within the blockchain network may have the right to record the cryptocurrency transaction (e.g., by winning against other computer nodes in the processing of the cryptocurrency transaction, etc.). The targeted computer node may generate a transaction block to be added to the blockchain associated with the cryptocurrency. According to the specification of the cryptocurrency, each transaction block may include a Coinbase transaction (also referred to as a “generation transaction”), which refers to the first transaction in the transaction block that records the tokens (e.g., coins) that have been mined by the computer node while generating the transaction block. In some embodiments, according to the computer-based protocol negotiated between the cryptocurrency transaction server and the targeted nodes during the handshake, the targeted computer node may generate a digital invoice (also referred to as a “Layer Two invoice”) for collecting the secondary transaction fee via the Layer Two cryptocurrency computer network. The targeted computer node may also encrypt the digital invoice using the public key distributed to the targeted computer node by the cryptocurrency transaction server during the handshake. In some embodiments, the targeted computer node may include the encrypted digital invoice within the transaction block, for example, by creating a new transaction record and incorporating the encrypted digital invoice within the new transaction record, by inserting the encrypted digital invoice into the transaction record corresponding to the cryptocurrency transaction, or inserting the encrypted digital invoice into the Coinbase transaction record. The advantage of inserting the encrypted digital invoice into the Coinbase transaction record is that no additional computer processing is required to modify an existing transaction record or to generate a new transaction record.

Since the transaction block is permanently recorded on the blockchain, which is distributed across the computer nodes within the blockchain network, the size of the transaction block can affect the storage efficiency and/or performance efficiency of the blockchain network (e.g., the performance of accessing transaction records within the blockchain, the performance of analyzing transaction records within the blockchain, the performance of maintaining and managing the blockchain, etc.). In order to improve the performance efficiency of the blockchain network, the cryptocurrency transaction server may be configured to reduce the size of the transaction block (or limit the size of the transaction block). In some embodiments, if the targeted computer node has generated and recorded a digital invoice for redeeming a secondary transaction fee associated with processing another transaction record in the past, instead of recording the encrypted digital invoice in the Coinbase transaction record, the targeted computer node may generate a hash value based on performing a hash algorithm on the digital invoice, and provide only the hash value (and not the digital invoice) in the Coinbase transaction record of the transaction block. In some embodiments, the targeted computer node may encrypt the hash value before including the encrypted hash value into the Coinbase transaction record.

The targeted computer node may insert the transaction record created by the cryptocurrency transaction server and corresponding to the cryptocurrency transaction (and possibly other transaction records processed by the targeted computer node) into the transaction block. The targeted computer node may record the transaction block on the blockchain associated with the cryptocurrency. By recording the transaction block on the blockchain and distributing the transaction block (or the modified blockchain) to other computer nodes in the blockchain network, the cryptocurrency transaction becomes an official transaction within the blockchain network.

In some embodiments, after broadcasting the transaction record corresponding to the cryptocurrency transaction to the computer nodes of the blockchain network (the Layer One cryptocurrency computer network), the cryptocurrency transaction server may monitor any new blocks being added to the blockchain associated with the cryptocurrency. When the cryptocurrency transaction server detects a new block being added to the blockchain, the cryptocurrency transaction server may determine whether the new block includes the transaction record corresponding to the cryptocurrency transaction and generated by the cryptocurrency transaction server. If the new block includes the transaction record corresponding to the cryptocurrency transaction, the cryptocurrency transaction server may extract the encrypted digital invoice from the transaction block (e.g., by accessing the Coinbase transaction record and extracting the encrypted digital invoice from the Coinbase transaction record).

In some embodiments, to determine the identity of the targeted computer node that processed the cryptocurrency transaction (e.g., the computer node that created the new transaction block), the cryptocurrency transaction server may attempt to decrypt the encrypted digital invoice using the private encryption keys generated for the targeted computer nodes. By attempting to decrypt the encrypted digital invoice using the private encryption keys, the cryptocurrency transaction server may identify the targeted computer node that processed the cryptocurrency transaction based on the one private encryption key used by the cryptocurrency transaction server to successfully decrypt the encrypted digital invoice (e.g., able to obtain data corresponding to a digital invoice after decrypting the encrypted digital invoice, etc.). The cryptocurrency transaction server may then transfer the secondary transaction fee to the identified computer node via the Layer Two cryptocurrency computer network.

In some embodiments, the cryptocurrency transaction server may include a data storage that stores all of the digital invoices generated by various targeted computer nodes and that have been processed in the past. The cryptocurrency transaction server may also generate a hash value for each digital invoice by performing a hash algorithm on the digital invoice, and pair the hash value with the digital invoice in the data storage (or a lookup table). When the Coinbase transaction record includes a hash value (or an encrypted hash value) instead of a digital invoice, the cryptocurrency transaction server may extract the encrypted hash value from the Coinbase transaction. After decrypting the encrypted hash value, the cryptocurrency transaction server may identify a corresponding digital invoice that is paired with the hash value in the data storage, and use the paired digital invoice to transfer the secondary transaction fee to the targeted computer node via the Layer Two cryptocurrency computer network using the digital invoice.

The computer-based protocol implemented by the cryptocurrency transaction server and the computer nodes enables the cryptocurrency transaction server to selectively target different subsets of computer nodes for processing different cryptocurrency transactions. In particular, under the framework disclosed herein, the cryptocurrency transaction server may determine different subsets of computer nodes for processing different cryptocurrency transactions according to different criteria (e.g., user-specified criteria, criteria determined based on attributes associated with the cryptocurrency transactions such as transaction amounts, identities of the parties involved in the cryptocurrency transactions, etc.). For example, the cryptocurrency transaction server may determine a first subset of computer nodes to be targeted for processing a first cryptocurrency transaction based on attributes associated with the first cryptocurrency transaction. The cryptocurrency transaction server may target the first subset of computer nodes by enabling a targeted computer node from the first subset of computer nodes to generate a digital invoice to be included in a new transaction block, and transferring the secondary transaction fee associated with the first cryptocurrency transaction to the targeted computer node via the Layer Two cryptocurrency computer network. The cryptocurrency transaction server may then determine a second subset of computer nodes to be targeted for processing a second cryptocurrency transaction based on attributes associated with the second cryptocurrency transaction. The cryptocurrency transaction server may target the second subset of computer nodes by enabling a targeted computer node from the second subset of computer nodes to generate a digital invoice to be included in a new transaction block, and transferring the secondary transaction fee associated with the second cryptocurrency transaction to the targeted computer node via the Layer Two cryptocurrency computer network.

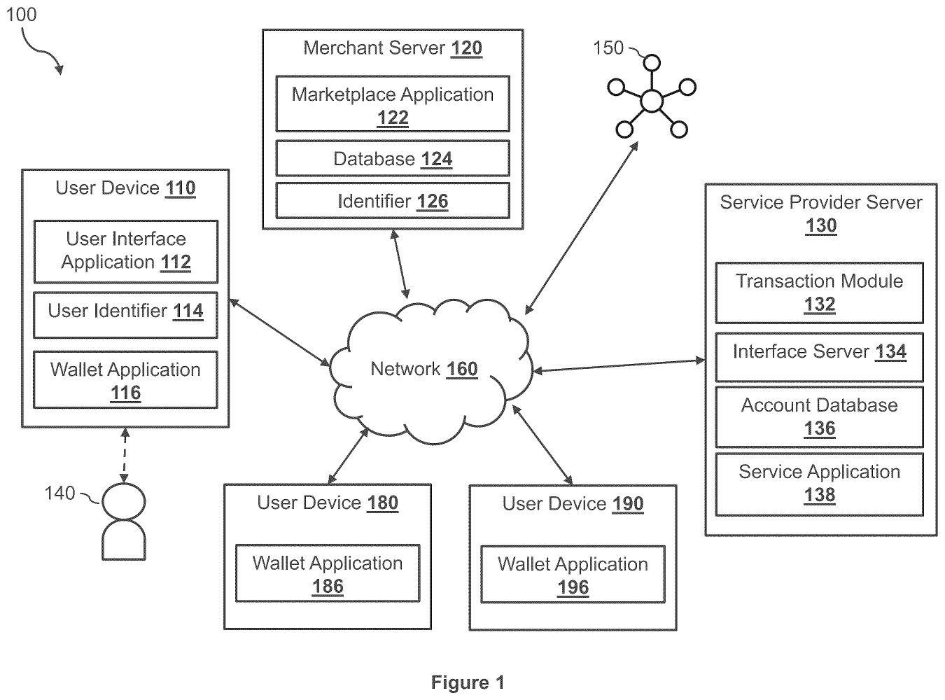

FIG. 1 illustrates a networked system 100, within which the cryptocurrency transaction framework may be implemented according to one embodiment of the disclosure. Note that the present techniques may be applied in many different computing and technological environments, however, and are not limited to those shown in the figures. The networked system 100 includes a service provider server 130, a merchant server 120, a blockchain network 150, and user devices 110, 180 and 190 that may be communicatively coupled with each other via a network 160. The network 160 may be implemented as a single network or a combination of multiple networks. For example, the network 160 may include the Internet and/or one or more intranets, landline networks, wireless networks, and/or other appropriate types of communication networks. In another example, the network 160 may comprise a wireless telecommunications network (e.g., cellular phone network) adapted to communicate with other communication networks, such as the Internet.

The user device 110 may be utilized by a user 140 to interact with the merchant server 120 and/or the service provider server 130 over the network 160. For example, the user 140 may use the user device 110 to conduct an online transaction with the merchant server 120 via websites hosted by, or mobile applications associated with, the merchant server 120. The user 140 may also log in to a user account to access account services or conduct electronic transactions (e.g., account transfers or payments, purchasing goods and/or services, etc.) with the service provider server 130. The user device 110 may be implemented using any appropriate combination of hardware and/or software configured for wired and/or wireless communication over the network 160. In various implementations, the user device 110 may include at least one of a wireless cellular phone, wearable computing device, PC, laptop, etc.

The user device 110 may include a user interface (UI) application 112 (e.g., a web browser, a mobile payment application, etc.), which may be utilized by the user 140 to interact with the merchant server 120 and/or the service provider server 130 over the network 160. In one implementation, the user interface application 112 includes a software program (e.g., a mobile application) that provides a graphical user interface (GUI) for the user 140 to interface and communicate with the service provider server 130, and/or the merchant server 120 via the network 160. In another implementation, the user interface application 112 includes a browser module that provides a network interface to browse information available over the network 160. For example, the user interface application 112 may be implemented, in part, as a web browser to view information available over the network 160.

The user device 110 may include a wallet application 116 configured to facilitate payments for the user 140. The wallet application 116 may be associated with a digital wallet of the user 140 such that funds (e.g., in a fiat currency, in a cryptocurrency, etc.) can be transferred from the digital wallet of the user 140 to another digital wallet of another user (e.g., the wallet application 186 of the user device 180, the wallet application 196 of the user device 190, or other wallet application associated with another entity such as the merchant server 120, etc.) using the wallet application 116. The wallet application 116 may be configured to communicate with the service provider server 130 to perform cryptocurrency transactions. The user 140, through the user interface provided by the wallet application 116 (or the user interface application 112) on the user device 110, may initiate a cryptocurrency transaction (e.g., transferring a particular amount in a cryptocurrency from the digital wallet of the user 140 to another digital wallet). For example, the user 140 may specify an identity of the recipient digital wallet, an amount in the cryptocurrency via the user interface of the wallet application 116, a transaction fee, and a set of criteria for targeting a subset of computer nodes for processing the cryptocurrency transaction.

The user device 110 may include at least one identifier 114, which may be implemented, for example, as operating system registry entries, cookies associated with the user interface application 112 and/or the wallet application 116, identifiers associated with hardware of the user device 110 (e.g., a media control access (MAC) address), or various other appropriate identifiers. In various implementations, the identifier 114 may be passed with a user login request to the service provider server 130 via the network 160, and the identifier 114 may be used by the service provider server 130 to associate the user 140 with a particular user account, a particular digital wallet, and/or a particular profile.

In various implementations, the user 140 is able to input data and information into an input component (e.g., a keyboard) of the user device 110. For example, the user 140 may use the input component to interact with the UI application 112 (e.g., to retrieve content from third-party servers such as the merchant server 120, to provide inputs related to a cryptocurrency transaction to the service provider server 130, etc.) and/or the wallet application 116.

Each of the user devices 180 and 190 may include similar hardware and software components as the user device 110 to enable their respective users to interact with the merchant server 120 and the service provider server 130 through the user devices 180 and 190. For example, the users of the user devices 110, 180, and 190 may use the respective devices to conduct electronic transactions (e.g., cryptocurrency transactions) through different user accounts of the service provider server 130 and/or through different digital wallets. Furthermore, each of the user devices 180 and 190 also includes a wallet application (e.g., the wallet applications 186 and 196, respectively), configured to perform cryptocurrency functionalities, in a similar manner as the wallet application 116.

The merchant server 120 may be maintained by a business entity (or in some cases, by a partner of a business entity that processes transactions on behalf of business entity). Examples of business entities include merchants, resource information providers, utility providers, real estate management providers, social networking platforms, etc., which offer various items for viewing, accessing, and/or purchasing, and process payments for the purchases. As shown, the merchant server 120 may include a merchant database 124 for identifying available items, which may be made available to the user devices 110, 180, and 190 for viewing and purchase by the user.

The merchant server 120 may include a marketplace application or server 122, which may be configured to provide information (e.g., displayable content) over the network 160 to the user interface application 112 of the user device 110. The marketplace application 122 may include a web server that hosts a merchant website for the merchant. For example, the user 140 of the user device 110 may interact with the marketplace application 122 through the user interface application 112 over the network 160 to search and view various items available for access and/or purchase in the merchant database 124. The merchant server 120 may be associated with at least one merchant identifier 126, which may be included as part of the one or more items made available for purchase so that, e.g., particular items are associated with the particular merchants. In one implementation, the merchant identifier 126 may include one or more attributes and/or parameters related to the merchant, such as business and banking information. The merchant identifier 126 may include attributes related to the merchant server 120, such as identification information (e.g., a serial number, a location address, GPS coordinates, a network identification number, etc.). The merchant server 120 may be associated with a digital wallet for receiving funds, including cryptocurrency, from other digital wallets for purchasing items from the business entity.

While only one merchant server 120 is shown in FIG. 1, it has been contemplated that multiple merchant servers, each associated with a different merchant, may be connected to the user device 110 and the service provider server 130 via the network 160.

The service provider server 130 may be maintained by a transaction processing entity or an online service provider, which may provide processing for electronic transactions between different entities (e.g., among the users of the user devices 110, 180, and 190, between a user and one or more business entities (e.g., the business entity associated with the merchant server 120, etc.), or other types of payees. As such, the service provider server 130 may include a service application 138, which may be adapted to interact with the user devices 110, 180, and 190, and/or the merchant server 120 over the network 160 to facilitate the searching, selection, purchase, payment of items, and/or other services offered by the service provider server 130. In one example, the service provider server 130 may be provided by PayPal®, Inc., of San Jose, California, USA, and/or one or more service entities or a respective intermediary that May provide multiple point of sale devices at various locations to facilitate transaction routings between merchants and, for example, service entities. In some embodiments, the service provider server 130 may correspond to the cryptocurrency transaction server as disclosed herein.

The service application 138 may include a payment processing application (not shown) for processing purchases and/or payments for electronic transactions between a user and a merchant or between any two entities (e.g., between two users, etc.). In one implementation, the payment processing application assists with resolving electronic transactions through validation, delivery, and settlement. As such, the payment processing application settles indebtedness between a user and a merchant, wherein accounts may be directly and/or automatically debited and/or credited of monetary funds.

The service provider server 130 may also include an interface server 134 that is configured to serve content (e.g., web content) to users and interact with users. For example, the interface server 134 may include a web server configured to serve web content in response to HTTP requests. In another example, the interface server 134 may include an application server configured to interact with a corresponding application (e.g., a service provider mobile application) installed on the user device 110 via one or more protocols (e.g., RESTAPI, SOAP, etc.). As such, the interface server 134 may include pre-generated electronic content ready to be served to users. For example, the interface server 134 may store a log-in page and is configured to serve the log-in page to users for logging into user accounts of the users to access various services provided by the service provider server 130, such as cryptocurrency transaction services as disclosed herein. The interface server 134 may also include other electronic pages associated with the different services (e.g., electronic transaction services, etc.) offered by the service provider server 130. As a result, a user (e.g., the user 140, users of the user devices 180 and 190, or a merchant associated with the merchant server 120, etc.) may access a user account associated with the user and access various services offered by the service provider server 130, by generating HTTP requests directed at the service provider server 130.

The service provider server 130 may be configured to maintain one or more user accounts and merchant accounts (or digital wallets) in an account database 136, each of which may be associated with a profile and may include account information associated with one or more individual users (e.g., the user 140 associated with user device 110, users associated with the user devices 180 and 190) and merchants. The account information may include an identifier of a digital wallet associated with each user account of a user. In one implementation, a user may have credentials to authenticate or verify identity with the service provider server 130. Thus, the service provider server may store the credentials of the users in corresponding records of the account database 136 associated with the user accounts.

The service provider server 130 may also include a transaction module 132 that implements the functionalities of the cryptocurrency transaction server as part of the framework discussed herein. In some embodiments, the transaction module 132 may communicate with the computer nodes within the blockchain network 150 (which is also referred to as a “Layer One cryptocurrency computer network”) associated with a cryptocurrency to facilitate the processing of cryptocurrency transactions. Specifically, the transaction module 132 may provide a user interface (e.g., through the interface server 134, via the user interface application 112, or via the wallet applications 116, 186, and 196, etc.) that enables users (e.g., the user 140, users of the user devices 180, 190, a merchant associated with the merchant server 120, etc.) to submit a request for processing a cryptocurrency transaction. Through the user interface, a user may specify transaction data associated with a cryptocurrency transaction, such as identities of the parties involved in the cryptocurrency transactions (e.g., an address associated with a sender digital wallet, an address associated with a recipient digital wallet, etc.), a transaction amount to be transferred from the sender digital wallet to the recipient digital wallet, and a transaction fee to be provided to a computer node for processing the cryptocurrency transaction. In addition, the user may also specify, via the user interface, a set of criteria for selecting a subset of computer nodes from the blockchain network 150 to be targeted for processing the cryptocurrency transaction.

According to various embodiments of the disclosure, the transaction module 132 may determine characteristics associated with different computer nodes within the blockchain network 150. For example, the transaction module 132 may generate and transmit programming code to each of the computer nodes within the blockchain network 150. Each of the computer nodes within the blockchain network 150 may execute the programming code. Based on executing the computer code, each computer node in the blockchain network 150 may access various attributes associated with the computer node (e.g., a location of the computer node, a processor type of the computer node, a memory capacity of the computer node, etc.). In some embodiments, based on executing the programming code, each computer node may also monitor characteristics of the computer node (e.g., a power usage, a computer memory usage, etc.) as the computer node processes a cryptocurrency transaction. In some embodiments, based on executing the programming code, each computer node may also access or determine power source information (e.g., power source of the computer node, such as solar, wind, coal, etc.). Each of the computer nodes within the blockchain network 150 may then transmit the information back to the transaction module 132.

In some embodiments, the transaction module 132 may determine a set of criteria for selecting targeted computer nodes for processing a cryptocurrency transaction. For example, the transaction module 132 may determine the set of criteria based on various attributes associated with the cryptocurrency transaction (e.g., the transaction amount, the identities of the parties involved in the cryptocurrency transaction, such as the sender digital wallet, the recipient digital wallet, etc.), such that a cryptocurrency transaction having a transaction amount above an amount threshold would require computer nodes having a power efficiency above an efficiency threshold to process the cryptocurrency transaction. In another example, the transaction module 132 may determine the set of criteria based on the user inputs received via the user interface. The set of criteria may be associated with the computer configuration associated with the computer nodes (e.g., a processor type of the computer node, an amount of memory in the computer node, etc.), the locations associated with the computer nodes, efficiency characteristics associated with processing a cryptocurrency transaction (e.g., a power consumption required for processing a cryptocurrency transaction, a computer memory usage required for processing a cryptocurrency transaction, etc.), attributes associated with a power source used for processing a cryptocurrency transaction (e.g., a ratio of clean vs. dirty power source, etc.), or any other type of criteria that is related to the computer nodes.

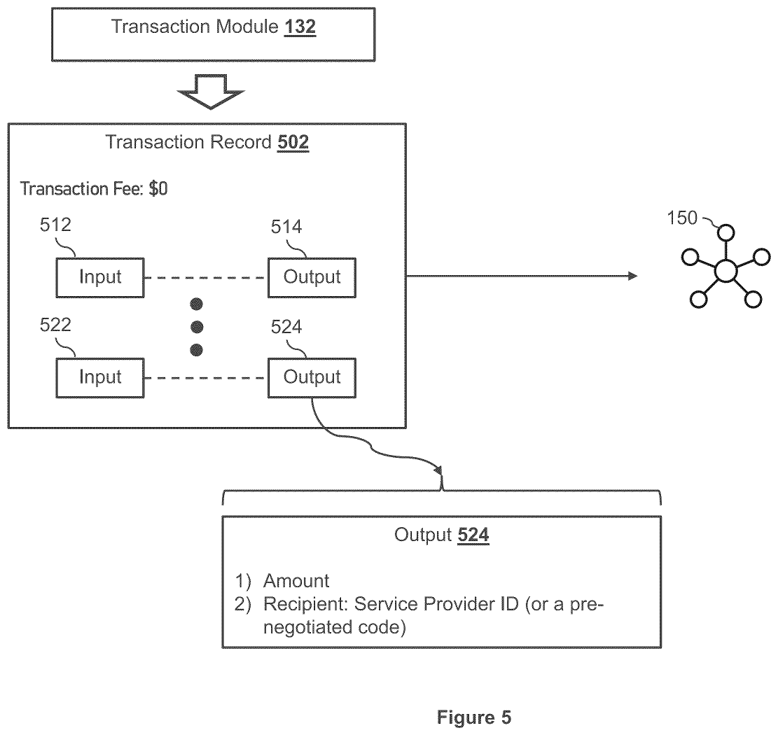

Based on the information retrieved from the computer nodes, the transaction module 132 may select, from the computer nodes within the blockchain network 150 associated with the cryptocurrency, a subset of computer nodes that satisfy the set of criteria. For example, when the set of criteria is associated with a ratio of clean power source and dirty power source, the transaction module 132 may select computer nodes from the blockchain network 150 that operate on power sources having a ratio of clean power source to dirty power source exceeding a threshold ratio. When the set of criteria is associated with a computer hardware configuration (e.g., a processor type, a computer memory type or capacity, etc.), the transaction module 132 may select computer nodes from the blockchain network 150 with attributes that satisfy the computer hardware configuration. The transaction module 132 may then generate, for the cryptocurrency transaction, a transaction record that targets the selected subset of computer nodes within the blockchain network 150, such that the subset of computer nodes has a higher likelihood of processing the cryptocurrency transaction than other computer nodes within the blockchain network 150. The generation of the transaction record and the protocols used by the cryptocurrency transaction framework for facilitating the selective targeting of computer nodes will be described in detail below with reference to FIGS. 5-9.

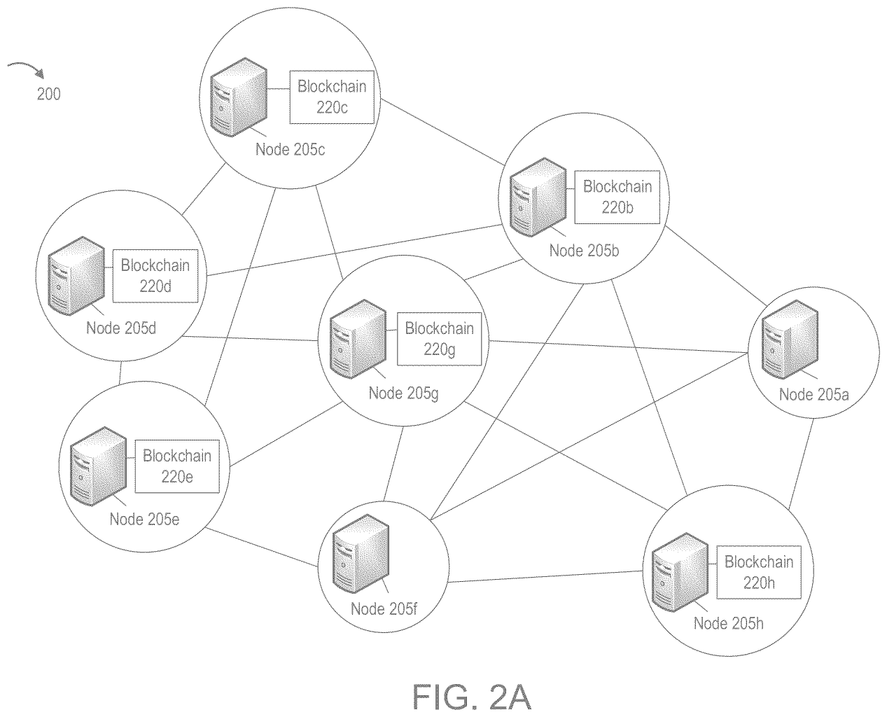

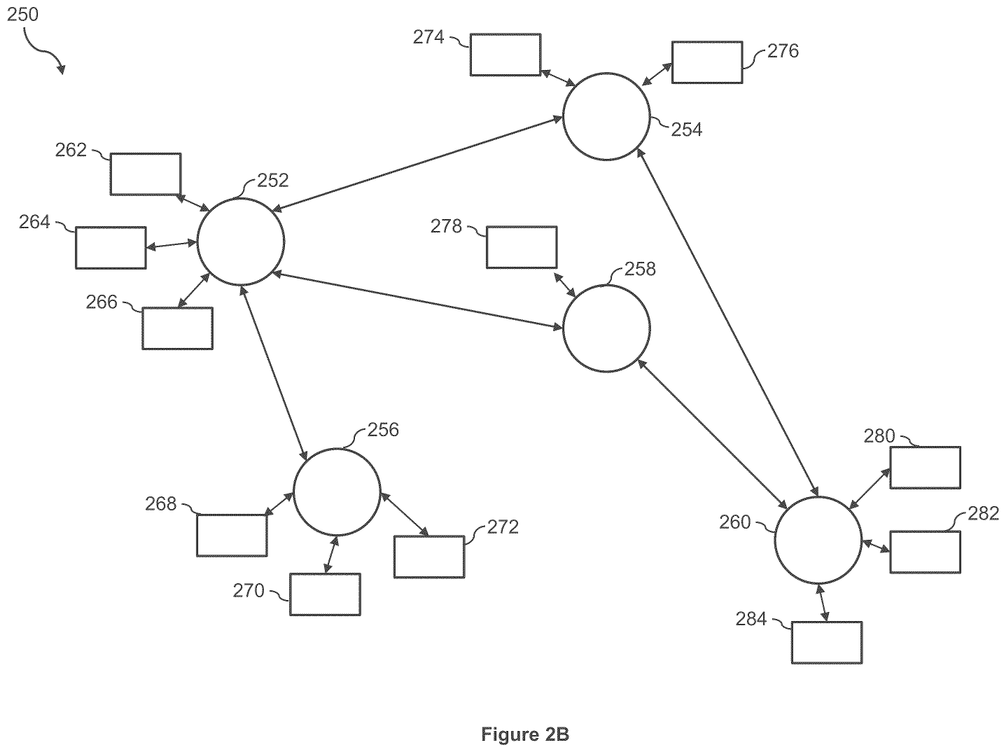

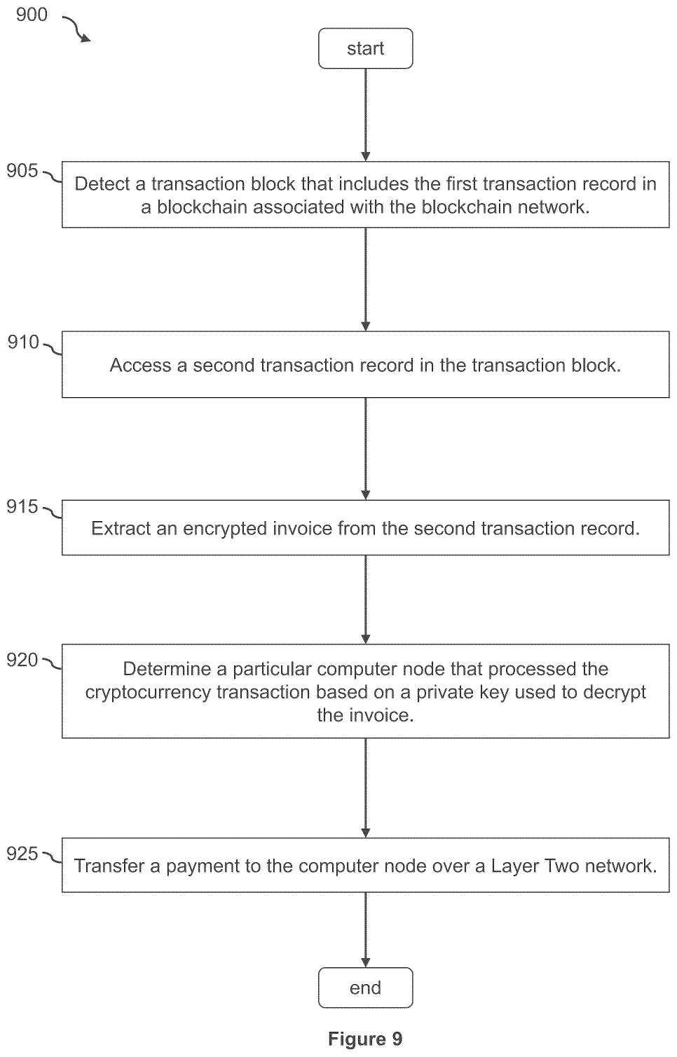

FIG. 2A shows an example blockchain network 200 comprising a plurality of interconnected computer nodes or devices 205a-h (generally referred to as nodes 205) according to various embodiments of the disclosure. In some embodiments, the blockchain network 200 may correspond to the blockchain network 150 in FIG. 1. Each of the computer nodes 205 in the blockchain network 200 may comprise a computing device (e.g., a computer server) described in more detail with reference to FIG. 9. Although FIG. 2A shows a single device 205, each of the computer nodes 205 may comprise a plurality of devices (e.g., a pool, a cluster, etc.). The blockchain network 200 may be associated with a blockchain 220 that records and tracks cryptocurrency transaction associated with a particular cryptocurrency (e.g., Bitcoin, Litecoin, Ethereum, etc.). Some or all of the nodes 205 may replicate and save an identical copy of the blockchain 220. For example, FIG. 2A shows that the nodes 205b-e and 205g-h store copies of the blockchain 220. The nodes 205b-e and 205g-h may independently update their respective copies of the blockchain 220 as discussed below.

FIG. 2B illustrates an exemplary Layer Two cryptocurrency computer network 250 according to various embodiments of the disclosure. In some embodiments, the network 250 is only a portion of a larger Layer Two cryptocurrency computer network (e.g., the lightning network, etc.). The network 250 is a separate network from the blockchain network 200 shown in FIG. 2A. As shown, the Layer Two cryptocurrency computer network 250 includes computer nodes 252, 254, 256, 258, and 260. Some of the computer nodes 252, 254, 256, 258, and 260 are connected with each other within the Layer Two cryptocurrency computer network 250. As discussed herein, two computer nodes may connect with each other within the Layer Two cryptocurrency computer network 200 by establishing a payment channel. In this example and as indicated by the connections in the Layer Two cryptocurrency computer network 200, a payment channel has been established between the computer nodes 252 and 254, another payment channel has been established between the computer nodes 252 and 256, another payment channel has been established between the computer nodes 252 and 258, another payment channel has been established between the computer nodes 254 and 260, and another payment channel has been established between the computer nodes 258 and 260. By establishing a payment channel between two computer nodes within the Layer Two cryptocurrency computer network, the two computer nodes can facilitate cryptocurrency transactions (e.g., transferring of funds in cryptocurrency) without using any resources from the Layer One cryptocurrency computer network (e.g., the computer nodes within the blockchain network 150 or 200). For example, transactions that are conducted using the Layer Two cryptocurrency computer network are not recorded on the blockchain (e.g., the blockchain 220) associated with the Layer One cryptocurrency computer network (e.g., the blockchain network 200).

Each computer node within the Layer Two cryptocurrency computer network 250 may be associated with one or more digital wallets. For example, the computer node 252 is associated with digital wallets 262, 264, and 266, the computer node 254 is associated with digital wallets 274 and 276, the computer node 256 is associated with digital wallets 268, 270, and 272, the computer node 258 is associated with a digital wallet 278, and the computer node 260 is associated with digital wallets 280, 282, and 284.

When a digital wallet is associated with a computer node within the Layer 2 cryptocurrency computer network 250, the digital wallet may use that associated computer node to perform a cryptocurrency transaction for the digital wallet through the Layer 2 cryptocurrency computer network 250, without requiring any resources from the Layer 1 cryptocurrency computer network.

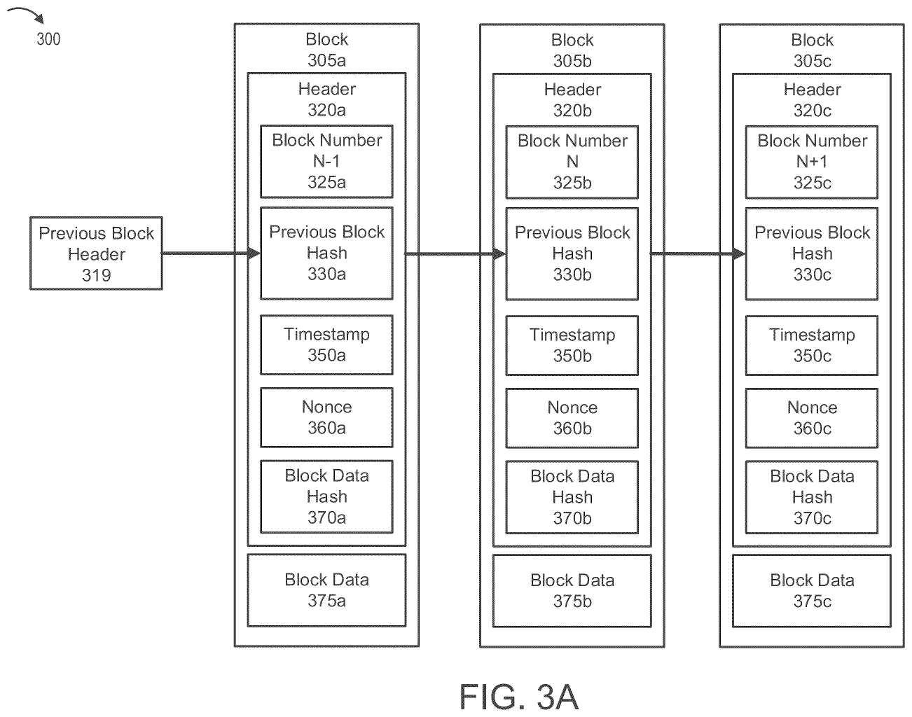

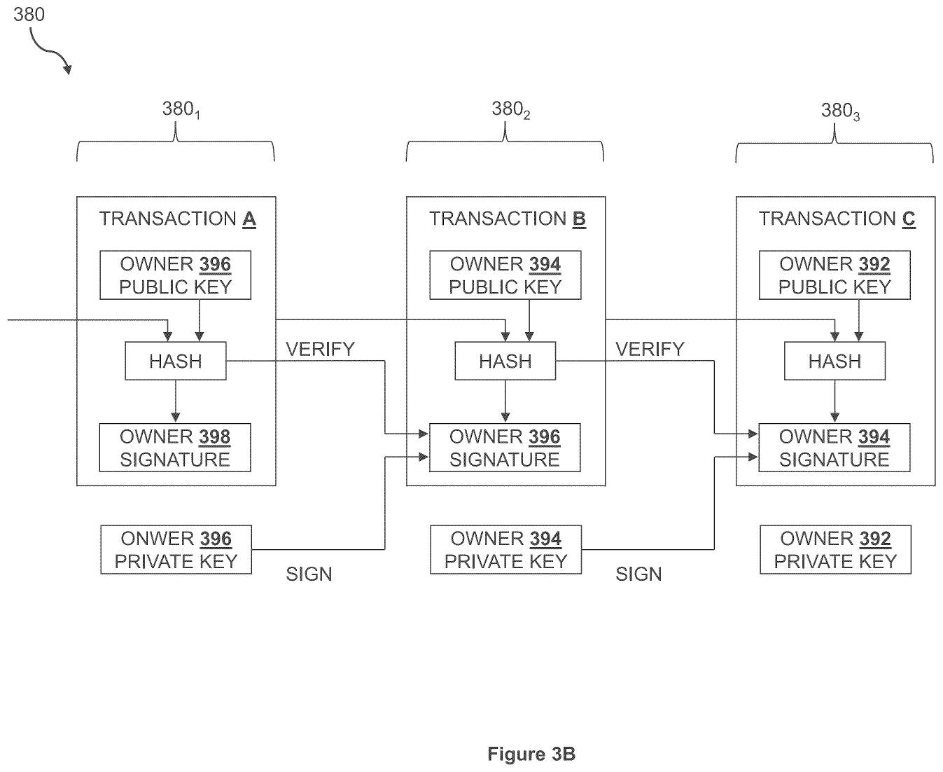

FIG. 3A shows an example blockchain 300, which may correspond to the blockchain 220 in FIG. 2A according to various embodiments of the disclosure. The blockchain 300 may comprise a plurality of blocks 305a, 305b, 305c, and so forth (generally referred to as blocks 305). The blockchain 300 comprises a first block (not shown), sometimes referred to as the genesis block. Each of the blocks 305 may comprise a record of one or a plurality of submitted and validated transactions. In some embodiments, each of the blocks 305 may also include a record associated with a Coinbase transaction that records a transfer of an amount of cryptocurrency (e.g., coins) to the miner (e.g., the computer node) that records the block to the blockchain 300. The blocks 305 of the blockchain 300 may be linked together and cryptographically secured. In some cases, the post-quantum cryptographic algorithms that dynamically vary over time may be utilized to mitigate ability of quantum computing to break present cryptographic schemes. Examples of the various types of data fields stored in a blockchain block are provided below. A copy of the blockchain 300 may be stored locally, in the cloud, on grid, for example by the nodes 205b-e and 205g-h, as a file or in a database.

### Blocks

Each of the blocks 305 may comprise one or more data fields. The organization of the blocks 305 within the blockchain 300 and the corresponding data fields may be implementation specific. As an example, the blocks 305 may comprise a respective header 320a, 320b, and 320c (generally referred to as headers 320) and block data 375a, 375b, and 375c (generally referred to as block data 375). The headers 320 may comprise metadata associated with their respective blocks 305. For example, the headers 320 may comprise a respective block number 325a, 325b, and 325c. As shown in FIG. 3A, the block number 325a of the block 305a is N−1, the block number 325b of the block 305b is N, and the block number 325c of the block 305c is N+1. The headers 320 of the blocks 305 may include a data field comprising a block size (not shown).

The blocks 305 may be linked together and cryptographically secured. For example, the header 320b of the block N (block 305b) includes a data field (previous block hash 330b) comprising a hash representation of the previous block N−1's header 320a. The hashing algorithm utilized for generating the hash representation may be, for example, a secure hashing algorithm 256 (SHA-256) which results in an output of a fixed length. In this example, the hashing algorithm is a one-way hash function, where it is computationally difficult to determine the input to the hash function based on the output of the hash function. Additionally, the header 320c of the block N+1 (block 305c) includes a data field (previous block hash 330c) comprising a hash representation of block N's (block 305b) header 320b.

The headers 320 of the blocks 305 may also include data fields comprising a hash representation of the block data, such as the block data hash 370a-c. The block data hash 370a-c may be generated, for example, by a Merkle tree and by storing the hash or by using a hash that is based on all of the block data. The headers 320 of the blocks 305 may comprise a respective nonce 360a, 360b, and 360c. In some implementations, the value of the nonce 360a-c is an arbitrary string that is concatenated with (or appended to) the hash of the block.

The blocks 305 may comprise respective block data 375a, 375b, and 375c (generally referred to as block data 375). The block data 375 may comprise a record of validated transactions that have also been integrated into the blockchain 200 via a consensus model (described below). As discussed above, the block data 375 may include a variety of different types of data in addition to validated transactions. Block data 375 may include any data, such as text, audio, video, image, or file, that may be represented digitally and stored electronically.

### Blockchain Transaction

In one example, a blockchain based transaction (e.g., a cryptocurrency transaction) may generally involve a transfer of data or value or an interaction between entities and described in more detail below. Referring back to FIG. 1, the service provider server 130 may include one or more applications, for example, the transaction module 132 configured to facilitate a cryptocurrency transaction between entities. The user 140 may request or initiate a transaction with another user via the user interface application 112 or the wallet application 116 executing on the user device 110. The transaction may be related to a transfer of value or data from a digital wallet of the user 140 to another digital wallet (e.g., the digital wallet of another user, another digital wallet of the user 140, a digital wallet associated with the service provider server 130, etc.). The value or data may represent money, a token, a contract, property, records, rights, status, supply, demand, alarm, trigger, or any other asset that may be represented in digital form. The transaction may represent an interaction between users, between a user and a merchant, or between a user and the service provider server 130.

FIG. 3B illustrates an example electronic token 380 according to one embodiment of the disclosure. Each electronic token 380 may correspond to an amount of cryptocurrency (e.g., a coin, etc.). In some embodiments, the electronic token 380 may be defined as a chain of digital signatures provided by previous owners of the electronic token 380 to subsequent owners of the electronic token. In the illustrated embodiment, the electronic token 380 is owned by an owner 392 (who may correspond to a user of the service provider server 130), and FIG. 3B illustrates how the electronic token 380 is defined by the digital signatures of the previous owners 394, 396, and 398. The electronic token 380 may also correspond to a coin used in a cryptocurrency transaction facilitated and/or processed by the service provider server 130. Specifically, in transaction A, a hash of the public key of owner 396 (i.e., the owner receiving, as a result of transaction A, the electronic token 3801 defined by digital signatures provided up to transaction A) and the previous transaction (not illustrated, but occurring prior to transaction A) was signed by owner 398 (i.e., the owner providing, as a result of transaction A, the electronic token 3801 defined by digital signatures provided up to transaction A) using a private key and added to an initial electronic token (which was defined by digital signatures provided up to the transaction prior to transaction A) such that the electronic coin 380 was transferred to owner 396.

Similarly, in transaction B, a hash of the public key of owner 394 (i.e., the owner receiving, as a result of transaction B, an electronic token 3802 defined by digital signatures provided up to transaction B) and transaction A was signed by owner 396 using a private key and added to the electronic token 3801 such that the electronic token 380 was transferred to owner 394. Similarly, in transaction C, a hash of the public key of owner 392 (i.e., the owner receiving, as a result of transaction C, the electronic token 3803 defined by digital signatures provided up to transaction C) and the transaction B was signed by owner 394 using a private key and added to the electronic coin 3802 such that the electronic token 380 was transferred to owner 392. As is understood in the art, any payee receiving an electronic token (e.g., owner 396 in transaction A, owner 394 in transaction B, and owner 392 in transaction C) can verify the signatures to verify the chain of ownership of the electronic token 380.

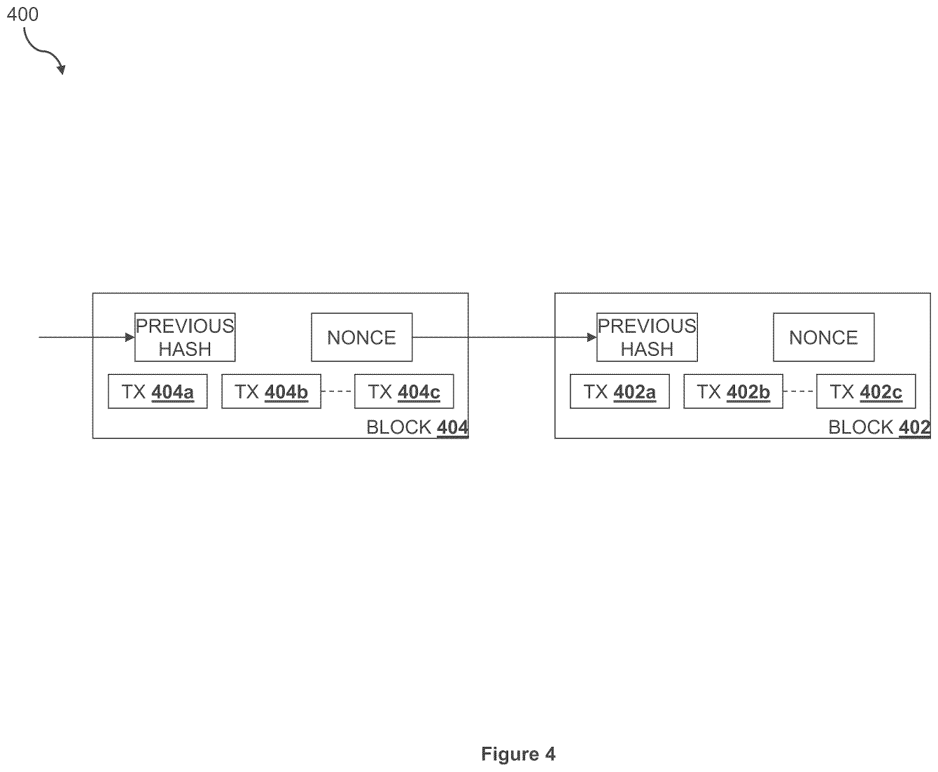

FIG. 4 illustrates an example ledger 400 according to one embodiment of the disclosure. The ledger 400 may correspond to a blockchain (e.g., the blockchain 220) that is maintained and managed by a blockchain network (e.g., the blockchain network 150, the blockchain network 200, etc.) comprising a network of computer nodes and associated with a cryptocurrency. When a transaction is processed by any one of the computer nodes in the blockchain network (e.g., a computer node from the targeted group of computer nodes, etc.), the transaction is recorded, along with one or more other transaction records, in a block that is added to the ledger 400 by the computer node. The ledger 400 operates to verify previous transactions (e.g., transfer) and ownership of electronic tokens (e.g., referring back to FIG. 3B, owner 396 in transaction A, owner 394 in transaction B, and owner 392 in transaction C) such that owners did not “double-spend” (e.g., use a private key to sign any previous transactions involving) that electronic token. To produce the ledger 400, a single device (e.g., the service provider server 130) or a distributed network of devices (e.g., the network of computer nodes associated with a blockchain) may operate to agree on a single history of transactions in the order in which they were received such that it may be determined that a transaction between a transferrer and a transferee of a token is the first transaction associated with that electronic token from the transferrer. Each device in the distributed network operates to collect new transactions into a block, and then to increment a proof-of work system that includes determining a value that when hashed with the block provides a required number of zero bits.

For example, for a block 402 that includes a plurality of transaction records 402a, 402b, and up to 402c, a device in the distributed network may increment a nonce in the block 402 until a value is found that gives a hash of the block 402 the required number of zero bits. The device may then “chain” the block 402 to the previous block 404 (which may have been “chained” to a previous block, not illustrated, in the same manner). When devices in the distributed network find the proof-of-work for a block, that block (e.g., block 402) is broadcasted to the distributed network, and other devices in the distributed network will accept that block if all the transactions in it are valid and not already transferred (which may be determined by creating the next block using the hash of the accepted block 402). The distributed network will always consider the longest chain of blocks to be the correct one, and will operate to continue to extend it. If a device receives two different versions of a block, it will work on the first block received, but save the second block received in case the branch of the chain that includes the second block becomes longer (at which point that device with switch to working on the branch of the chain that includes the second block).

Referring back to FIG. 1, as discussed herein, the transaction module 132 may communicate with the blockchain network 150 to facilitate the processing of a cryptocurrency transaction. In particular, once the transaction module 132 has selected a subset of computer nodes that satisfies the set of criteria (e.g., targeted computer nodes) for processing a cryptocurrency transaction, the transaction module 132 may communicate with and perform a computer-based handshake with the subset of computer nodes. In some embodiments, the transaction module 132 may perform the computer-based handshake with the subset of computer nodes according to a computer-based protocol for targeting the subset of computer nodes in association with the cryptocurrency transaction. As part of the handshake, the transaction module 132 may generate (or otherwise determine) an indicator (e.g., a code) that can be included in a transaction record for indicating that the transaction record is generated to target the targeted computer nodes. For example, the code may include an identifier associated with the service provider server 130 (e.g., an address associated with a digital wallet of the service provider server 130) or an arbitrarily (e.g., randomly) generated code (e.g., an alphanumeric code, a machine-readable code, etc.).

In addition, the transaction module 132 may generate pairs of asymmetrical encryption keys for the targeted computer nodes and distribute the keys to the targeted computer nodes. The encryption keys will be used by the transaction module 132 for verifying the identity of the computer node that processes the cryptocurrency transaction such that the correct computer node will be paid with the secondary transaction fee via the Layer Two cryptocurrency computer network (e.g., the network 250). For example, the transaction module 132 may generate a pair of corresponding encryption keys (e.g., a private encryption key and a public encryption key) for each targeted computer node, and may distribute one of the corresponding encryption keys (e.g., the public encryption key), but not the other one of the corresponding encryption keys (e.g., the private encryption key), to the targeted computer node.

Upon receiving a request for processing a cryptocurrency transaction (e.g., from a user via the user interface), the transaction module 132 may generate a transaction record based on the transaction data associated with the cryptocurrency transaction (e.g., obtained via a user interface from a user). The transaction record may be broadcasted to the computer nodes in the blockchain network 150 such that the computer nodes in the blockchain network 150 may compete to process the cryptocurrency transaction (e.g., recording the transaction record on the blockchain, such as the blockchain 200). In some embodiments, the transaction record may be generated by the transaction module 132 to target a specific subset of computer nodes (also referred to as “a targeted group of computer nodes” or “targeted computer nodes”) such that it is more likely that a targeted computer node (e.g., a computer node within the specific subset of computer nodes) would process the cryptocurrency transaction than a non-targeted computer node.

FIG. 5 illustrates an example transaction record 502 generated for selectively targeting certain computer nodes for processing a cryptocurrency transaction according to various embodiments of the disclosure. In some embodiments, the transaction module 132 may generate the transaction record 502 based on the transaction data associated with the cryptocurrency transaction and received from the user via the user interface. The transaction record 502 may include multiple data fields, such as a transaction identifier (not shown), which can be generated by performing a hash function to the transaction data, a transaction fee specifying an amount to be paid to the computer node that processes the cryptocurrency transaction, and one or more transaction input/output pairs that specify one or more sources of the funds involved in the cryptocurrency transaction, and one or more recipients of the corresponding funds from the one or more transaction inputs.

As shown in FIG. 5, the transaction module 132 may insert a first transaction input/output pair, including a transaction input 512 and a transaction output 514, in the transaction record 502 based on the transaction data provided by the user. For example, the transaction input 512 may specify a source of unspent funds (e.g., a reference to a transaction output in another transaction record that transferred funds to the sender digital wallet and previously recorded on the blockchain 220, etc.). The transaction output 514 may specify an identity of the recipient (e.g., an address of the recipient digital wallet, etc.).

In some embodiments, in order to target a subset of computer nodes according to the cryptocurrency transaction framework, the transaction module 132 may perform two modifications to the transaction record 502. First, instead of indicating the actual transaction fee amount specified by the parties involved in the cryptocurrency transaction (e.g., as provided by the user via the user interface), the transaction module 132 may indicate null (or zero) or a nominal value corresponding to a minimum amount allowed by the cryptocurrency network as the transaction fee in the transaction record 502. By indicating a lower transaction fee (e.g., zero transaction fee) than what is typically provided for processing other cryptocurrency transactions, the computer nodes in the blockchain network 150 are likely to be disincentivized from processing the cryptocurrency transaction.

Second, the transaction module 132 may insert another transaction input/output pair in the transaction record 502 for indicating to the subset of computer nodes that satisfy the set of criteria (e.g., the targeted computer nodes) that a secondary transaction fee is available to a targeted computer node that processes the cryptocurrency transaction. The transaction input/output pair may include a transaction input 522 that specifies a source of another unspent funds (which may correspond to the actual transaction fee amount specified by the user), and a transaction output 524 that includes the pre-negotiated code during the handshake between the transaction module 132 and the targeted computer nodes. In some embodiments, the secondary transaction fee may correspond to the actual transaction fee amount indicated by the parties involved in the cryptocurrency transaction (e.g., the user who initiated the cryptocurrency transaction, etc.). As such, the transaction output 524 may also specify the secondary transaction fee amount.

After generating the transaction record 502, the transaction module 132 may broadcast the transaction record 502 to the computer nodes in the blockchain network 150. By broadcasting the transaction record 502 to the blockchain network 150, each of the computer nodes in the blockchain network 150 would receive a notification of such a cryptocurrency transaction. For any other transaction records that were not generated according to the cryptocurrency transaction framework as disclosed herein, most (or all) of the computer nodes in the blockchain network 150 would participate in processing the cryptocurrency transaction (e.g., by performing the specified computations to compete in earning the right to record the transaction records, etc.). However, based on the low (e.g., zero) transaction fee indicated in the transaction record 502, the non-targeted computer nodes would be disincentivized from participating in processing the cryptocurrency transaction, as the cost (e.g., power consumption cost, etc.) for processing the cryptocurrency transaction incurred by the corresponding miners would exceed the transaction fee that they can receive by processing the cryptocurrency transaction.

For example, when a non-targeted computer node inspects the transaction record 502, the non-targeted computer node may determine that the transaction fee associated with the cryptocurrency transaction is zero or other minimal amount. The non-targeted computer node may determine not to participate in the processing of the cryptocurrency transaction based on the transaction fee. On the other hand, when a targeted computer node inspects the transaction record 502, the targeted computer node may notice the zero or minimal transaction fee associated with the cryptocurrency transaction, but also determines that a secondary non-minimal transaction fee is available to the targeted computer node based on the pre-negotiated code being included within the transaction output 524 of the transaction record 502. Thus, the targeted computer node may determine to participate in the processing of the cryptocurrency transaction based on the secondary transaction fee and the knowledge that there is less competition for processing the cryptocurrency transaction. If the targeted computer node determines to participate in the processing of the cryptocurrency transaction, the targeted computer node may generate a new block for recording the transaction record 502 and other transaction records. In some embodiments, the targeted computer node may include information in the new block in order to collect (e.g., redeem) the secondary transaction fee associated with the cryptocurrency transaction.

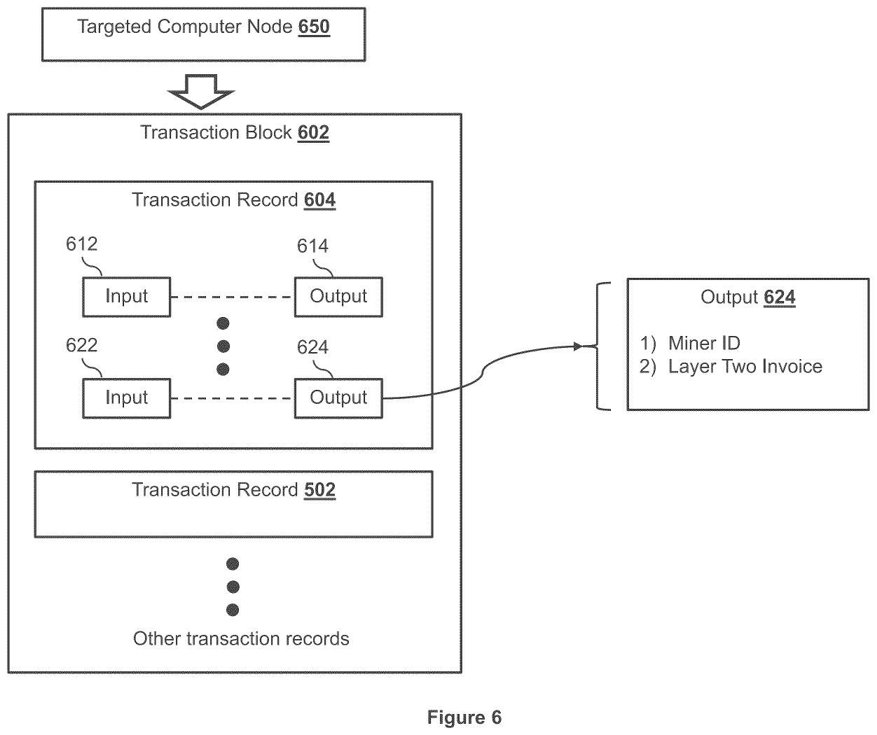

FIG. 6 illustrates an example transaction block 602 generated by a targeted computer node for recording a cryptocurrency transaction according to various embodiments of the disclosure. In some embodiments, a targeted computer node 650 that determines to participate in the processing of the cryptocurrency transaction may generate the transaction block 602 for recording the cryptocurrency transaction on the blockchain (e.g., the blockchain 220). As such, the targeted computer node 650 may include the transaction record 502 associated with the cryptocurrency transaction in the transaction block 602.

In some embodiments, the targeted computer node 650 may also generate a transaction record 604, that corresponds to a Coinbase transaction, which is the first transaction recorded in the transaction block 620 that records the tokens (e.g., coins) that have been mined by the targeted computer node 650 while generating the transaction block 602. As shown in FIG. 6, the transaction record 604 includes one or more transaction pairs, including a transaction input 612 and a transaction output 614 that records the transfer of tokens (that has been mined by the targeted computer node 650) to the targeted computer node 650.

In order to redeem the secondary transaction fee for processing the cryptocurrency transaction, the targeted computer node 650 may generate a digital invoice that corresponds to a Layer Two cryptocurrency computer network associated with the blockchain network 150. In some embodiments, the transaction module 132 may transfer the secondary transaction fee to the targeted computer node 650 via the Layer Two cryptocurrency computer network based on the digital invoice.

The targeted computer node 650 may encrypt the digital invoice using the public key distributed by the transaction module 132 during the handshake. The encryption of the digital invoice using the public key enables the transaction module 132 to verify the identity of the targeted computer node 650 when the transaction module 132 obtains the encrypted invoice. The targeted computer node 650 may incorporate the encrypted invoice into the transaction block 602 before adding the transaction block 602 to the blockchain. In some embodiments, the targeted computer node 650 may incorporate the encrypted invoice within the transaction record 502. In some embodiments, the targeted computer node 650 may generate a new transaction record to be included in the transaction block 602 as an additional transaction record, and incorporate the encrypted invoice within the new transaction record.

In some embodiments, the targeted computer node 650 may incorporate the encrypted invoice into the transaction record 604 (e.g., the Coinbase transaction record). Incorporating the encrypted invoice in the transaction record 604 is advantageous since the targeted computer node 650 is not required to generate an additional transaction record or modify an existing record 502 generated by the transaction module 132, which further enhances the computer processing efficiency for recording the cryptocurrency transaction. In some embodiments, the targeted computer node 650 may generate an additional transaction input/output pair for the transaction record 604. The transaction input/output pair may include a transaction input 622 and a transaction output 624. In some embodiments, the targeted computer node 650 may incorporate the encrypted invoice into the transaction output 624. In some embodiments, the targeted computer node 650 may also include an identifier associated with the targeted computer node 650 (e.g., an address of a digital wallet associated with the targeted computer node 650) in the transaction output 624, to notify the transaction module 132 the identity of the computer node that processed the cryptocurrency transaction, such that the transaction module 132 may transfer the secondary transaction fee to the correct computer node.

If the targeted computer node 650 is selected to record the cryptocurrency transaction (e.g., winning against other computer nodes in the specified computations, such as the generation of a nonce, etc.), the targeted computer node may add the transaction block 602 to its copy of the blockchain 220, and may broadcast the modified blockchain 220 to the other computer nodes in the blockchain network 200. By recording the new block in the blockchain 220, the transaction records 604 and 502 become official transactions within the blockchain network 150, which enables the transaction module to access and/or use the secondary transaction fee in another cryptocurrency transaction based on the transaction output 524 of the transaction record 502.

In some embodiments, after broadcasting the transaction record 502 to the blockchain network 150, the transaction module 132 may monitor any changes to the blockchain 220. For example, the transaction module 132 may access one or more copies of the blockchain 220 from one or more computer nodes within the blockchain network 200 (e.g., periodically, etc.) and compare the copies against a previous version of the blockchain 220. When the transaction module 132 detects a new block (e.g., the transaction block 602) being added to the blockchain 220, the transaction module 132 may first determine whether the new block includes the transaction record 502 associated with the cryptocurrency transaction. If the new block includes the transaction record 502, the transaction module 132 may access the Coinbase transaction record (e.g., the transaction record 604), and extract the encrypted digital invoice (and possibly the identity of the targeted computer node that recorded the transaction block 602, if available) from the Coinbase transaction record.

In some embodiments, to determine (or verify) the identity of the targeted computer node that processed the cryptocurrency transaction (e.g., the computer node that created the new transaction block 602), the transaction module 132 may attempt to decrypt the encrypted digital invoice using the private encryption keys generated for the targeted computer nodes during the handshake. By attempting to decrypt the encrypted digital invoice using the private encryption keys, the transaction module 132 may identify the targeted computer node (e.g., the targeted computer node 650) that processed the cryptocurrency transaction based on the one private encryption key used by the transaction module 132 to successfully decrypt the encrypted digital invoice.

After identifying the targeted computer node that processed the cryptocurrency transaction, the transaction module 132 may transfer the secondary transaction fee to the identified targeted computer node 650 via the Layer Two cryptocurrency computer network (e.g., the Layer Two cryptocurrency computer network 250). For example, the transaction module 132 may identify a path (e.g., via one or more payment channels) between a digital wallet associated with the service provider server 130 and a digital wallet associated with the targeted computer node. The transaction module 132 may then use the decrypted digital invoice to transfer funds corresponding to the secondary transaction fee to the digital wallet associated with the targeted computer node through the one or more payment channels.

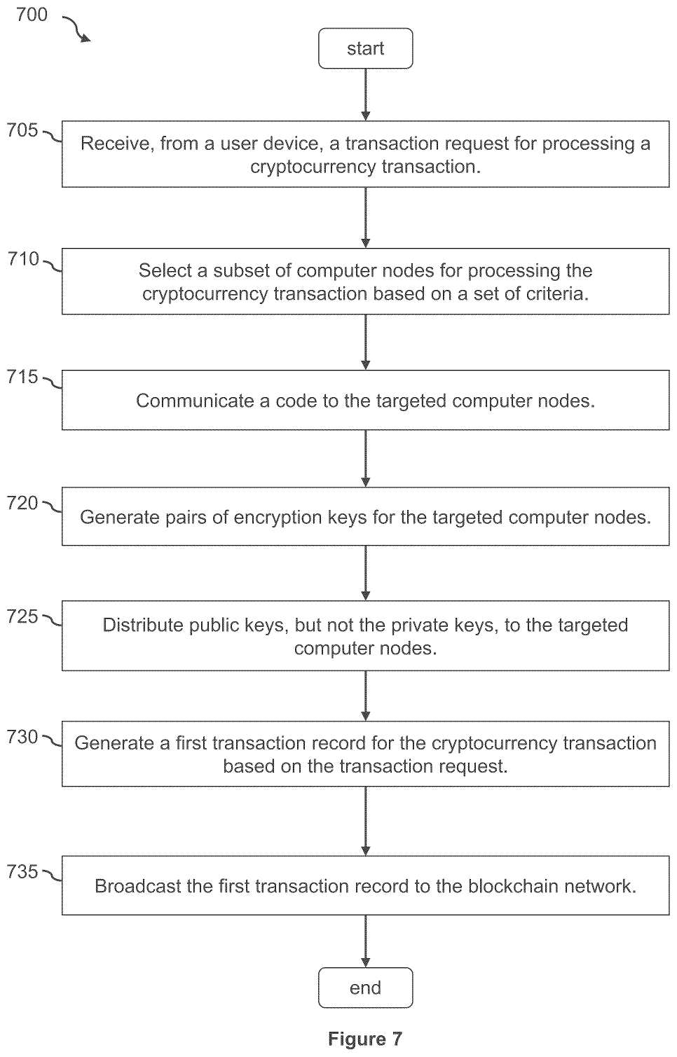

FIG. 7 illustrates a process 700 for selectively targeting a subset of computer nodes in a blockchain network for processing a cryptocurrency transaction according to various embodiments of the disclosure. In some embodiments, at least a portion of the process 700 may be performed by the transaction module 132. The process 700 may begin by receiving (at step 705), from a user device, a transaction request for processing a cryptocurrency transaction. For example, the transaction module 132 may provide a user interface (e.g., via the interface server 134, the wallet applications 116, 186, 196, etc.) to interact with the users. A user (e.g., the user 140) may submit a request for processing a cryptocurrency transaction via the user interface. The request may include transaction data associated with the cryptocurrency transaction, such as a transaction amount, identities of the parties involved in the cryptocurrency transaction (e.g., an address associated with a sender digital wallet, an address associated with a recipient digital wallet, etc.).

The process 700 selects (at step 710) a subset of computer nodes for processing the cryptocurrency transaction based on a set of criteria. For example, the transaction module 132 may determine the set of criteria based on the transaction data, such as the transaction amount and/or the identities of the parties involved in the cryptocurrency transaction. In another example, the transaction module 132 may determine the set of criteria based on user inputs provided by the user through the user interface. As discussed herein, the set of criteria may be associated with a computer configuration, a processing efficiency, a memory usage efficiency, a power source for processing the cryptocurrency transaction. Transaction module 132 may also obtain characteristics (e.g., a computer configuration, a processing efficiency, a memory usage efficiency, power source information, etc.) associated with each of the computer nodes within the blockchain network 150. The transaction module 132 may determine a subset of computer nodes that satisfies the set of criteria. In some embodiments, if none or only a small subset (e.g., zero, 1, or another threshold number) of computer nodes satisfy the set of criteria, the selection criteria may be relaxed such that more computer nodes meet the relaxed criteria.

After selecting the subset of computer codes for processing the cryptocurrency transaction, the process 700 communicates (at step 715) a code to the targeted computer nodes, generates (at step 720) pairs of encryption keys for the targeted computer nodes, and distributes (at step 725) public keys, but not the private keys, to the targeted computer nodes. For example, the transaction module 132 may perform a computer-based handshake with the targeted computer nodes. The handshake may include the transaction module 132 determining a code that can be included in a transaction record to indicate that the transaction record targets the subset of computer nodes. The code may include an identifier associated with the service provider server 130 (e.g., an address of a digital wallet associated with the service provider server 130, etc.) or an arbitrarily generated code.

The transaction module 132 may also generate pairs of encryption keys for the subset of computer nodes selected for processing the cryptocurrency transaction (also referred to as “targeted computer nodes”). Each pair of encryption keys may be generated to a distinct targeted computer node, and may include a private key and a public key. The transaction module 132 may distribute the public keys, but not the private keys, to the corresponding target computer nodes. The private keys may be used by the transaction module 132 subsequently to verify the identity of the computer node that processes the cryptocurrency transaction.

The process then generates (at step 730) a first transaction record for the cryptocurrency transaction based on the transaction request and broadcasts (at step 735) the first transaction record to the blockchain network. For example, the transaction module 132 may broadcast the transaction record 502 to the computer nodes in the blockchain network 150. For example, the transaction module 132 may generate the transaction record 502 for the cryptocurrency transaction. The transaction module 132 may specify, in the transaction record 502, a zero (or a nominal) transaction fee for disincentivizing non-targeted computer nodes from participating in the processing of the cryptocurrency transaction. In addition, the transaction module 132 may insert an additional transaction input/output pair corresponding to a secondary non-nominal transaction fee that is available only to the targeted computer nodes. The additional transaction input/output pair may include the transaction output 524 that includes the code and indicates that the service provider server 130 is the recipient for the funds referenced in the transaction input 522. The code included in the transaction output 524 acts as an alert to the targeted computer nodes that the transaction record 502 targets the targeted computer nodes, and that a secondary transaction fee is available to the targeted computer nodes. The transaction module 132 may then broadcast the transaction record 502 to the computer nodes in the blockchain network 150.

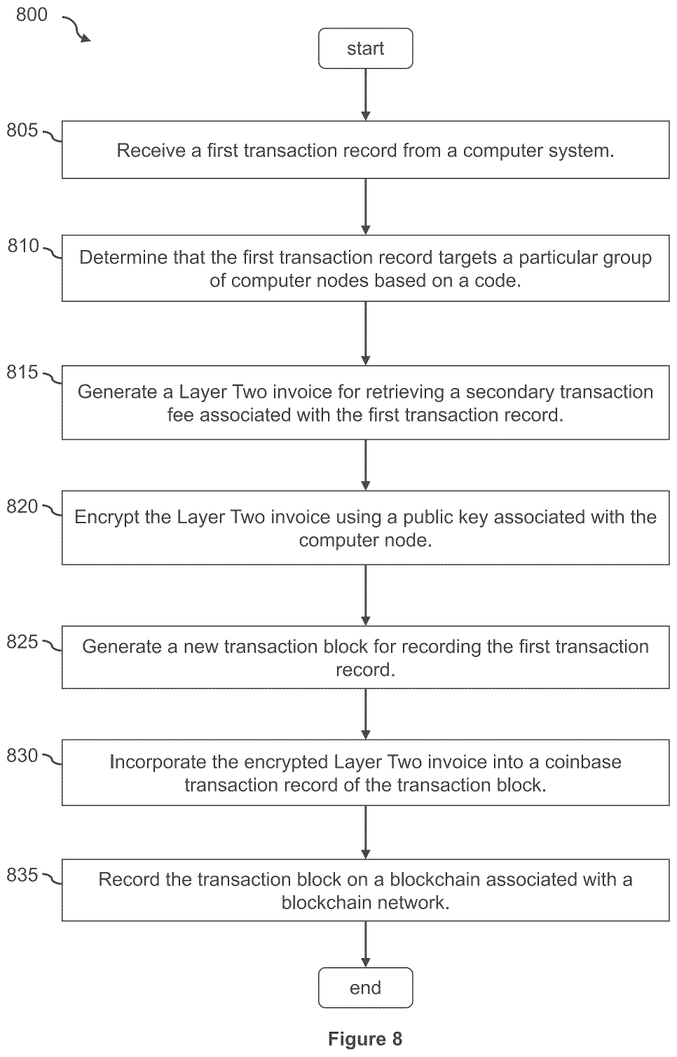

FIG. 8 illustrates a process 800 for redeeming a secondary transaction fee according to various embodiments of the disclosure. In some embodiments, at least a portion of the process 800 may be performed by a targeted computer node. The process 800 may begin by receiving (at step 805) a first transaction record from a computer system. In some embodiments, the first transaction record referred to here is a targeted transaction record generated by the transaction module 132 for targeting a subset of computer nodes, which is different from the Coinbase transaction record as discussed herein. For example, the targeted computer node 650 may receive the transaction record 502 broadcasted by the transaction module 132.

The process 800 determines (at step 810) that the first transaction record targets a particular group of computer nodes based on a code. For example, by inspecting the transaction record 502, the targeted computer node 650 may determine that a pre-negotiated code that was communicated to the targeted computer node 650 by the transaction module 132 is included in the transaction record 502 (e.g., included in one of the transaction outputs within the transaction record 502). Based on the code included in the transaction record 502, the targeted computer node 650 may determine that the transaction record 502 targets a particular group of computer nodes that includes the targeted computer node 650.

After determining that the first transaction record targets the particular group of computer nodes, the process 800 generates (at step 815) a Layer Two invoice for retrieving a secondary transaction fee associated with the transaction record, and encrypts (at step 820) the Layer Two invoice using a public key associated with the computer node. For example, the targeted computer node 650 may generate a Layer Two invoice based on an amount associated with a secondary transaction fee included in the transaction record 502 (e.g., indicated in the transaction input 522 and/or the transaction output 524). The targeted computer node 650 may then encrypt the Layer Two invoice using the public key provided by the transaction module 132 during the handshake.

The process 800 then generates (at step 825) a new transaction block for recording the first transaction record and incorporates (at step 830) the encrypted Layer Two invoice into the Coinbase transaction record of the transaction block. For example, the targeted computer node 650 may generate the transaction block 602 for recording the transaction record 502. As discussed herein, each transaction block may include a Coinbase transaction record that records a transfer of coins that has been mined by a computer node during the generation of the transaction block to the computer node. In some embodiments, the Coinbase transaction record may include additional information. As such, the targeted computer node 650 may incorporate the encrypted Layer Two invoice into the Coinbase transaction record (e.g., within the transaction output 624 of the transaction record 604).

The process 800 records (at step 835) the transaction block on a blockchain associated with the blockchain network. For example, if the targeted computer node is selected to record the transaction record 502, the targeted computer node 650 may add the transaction block 602 on a copy of the blockchain associated with the targeted computer node 650. The targeted computer node 650 may also transmits the copy of the blockchain to other computer nodes within the blockchain network 150 such that the transaction block 602 becomes an official block within the blockchain 220.

FIG. 9 illustrates a process 900 for transferring the secondary transaction fee to a targeted computer node via a Layer Two cryptocurrency computer network according to various embodiments of the disclosure. In some embodiments, at least a portion of the process 900 may be performed by the transaction module 132. The process 900 may begin by detecting (at step 905) a transaction block that includes the first transaction record in a blockchain associated with the blockchain network. For example, after broadcasting the transaction record 502 to the computer nodes in the blockchain network 150, the transaction module 132 may monitor any changes to the blockchain 220 associated with the blockchain network 150. For example, the transaction module 132 may access one or more copies of the blockchain 220 from one or more computer nodes within the blockchain network 150 and compare the copies to a previous version of the blockchain 220. If a new transaction block (e.g., the transaction block 602) has been added to the blockchain 220, the transaction module 132 may inspect the new transaction block to determine whether the transaction record 502 has been recorded in the new transaction block.

The process 900 then accesses (at step 910) a second transaction record in the transaction block and extracts (at step 915) an encrypted invoice from the second transaction record. For example, once the transaction module 132 determines that the new transaction block added to the blockchain 220 includes the transaction record 502, the transaction module 132 may access another transaction record included in the new transaction block (e.g., a Coinbase transaction record, such as the transaction record 604). The transaction module 132 may extract, from the transaction record 604, the encrypted Layer Two invoice generated by the targeted computer node 650.

The process determines (at step 915) a particular computer node that processed the cryptocurrency transaction based on a private key used to decrypt the invoice and transfers (at step 920) a payment to the computer node over a Layer Two network. For example, the transaction module 132 may attempt to decrypt the encrypted invoice using one or more private keys generated for the targeted computer nodes. The transaction module 132 may identify the targeted computer node (e.g., the targeted computer node 650) that has processed the cryptocurrency transaction associated with the transaction record 502 based on the private key used to successfully decrypt the encrypted invoice. Once the targeted computer node 650 has been identified, the transaction module 132 may use the Layer Two invoice to transfer the secondary transaction fee to the targeted computer node 650 via the Layer Two cryptocurrency computer network.

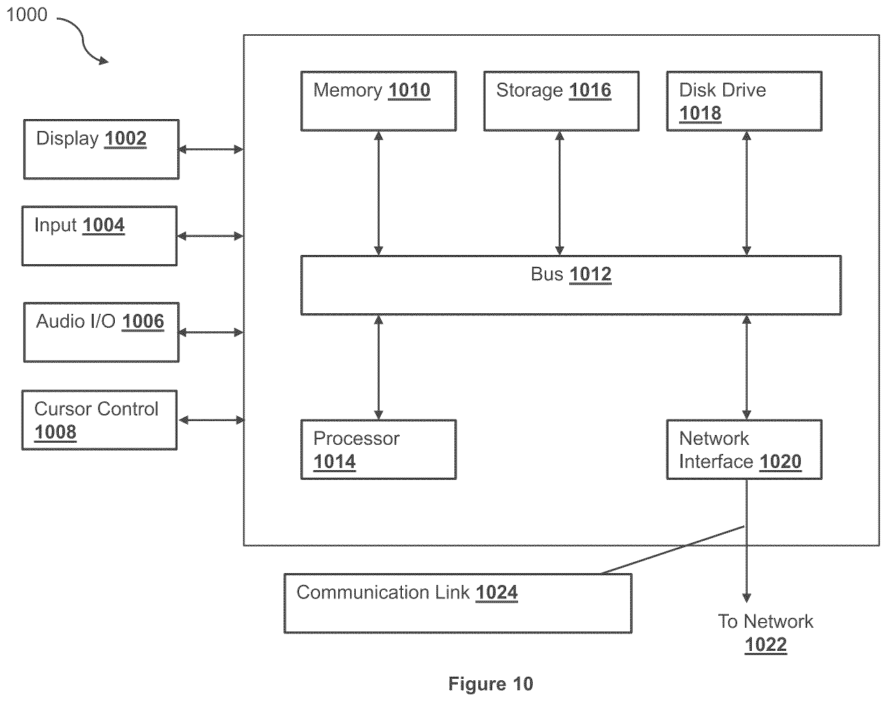

FIG. 10 is a block diagram of a computer system 1000 suitable for implementing one or more embodiments of the present disclosure, including the service provider server 130, the merchant server 120, the user devices 110, 180, and 190, and each of the computer nodes in the blockchain network 150, such as computer nodes 205. In various implementations, each of the devices 110, 180, and 190 may include a mobile cellular phone, personal computer (PC), laptop, wearable computing device, etc. adapted for wireless communication, and each of the service provider server 130, the merchant server 120, and the computer nodes in the blockchain network 150 such as the computer nodes 205 may include a network computing device, such as a server. Thus, it should be appreciated that the devices/servers 110, 120, 130, 180, 190, and the computer nodes 205 in the blockchain network 150 may be implemented as the computer system 1000 in a manner as follows.

The computer system 1000 includes a bus 1012 or other communication mechanism for communicating information data, signals, and information between various components of the computer system 1000. The components include an input/output (I/O) component 1004 that processes a user (i.e., sender, recipient, service provider) action, such as selecting keys from a keypad/keyboard, selecting one or more buttons or links, etc., and sends a corresponding signal to the bus 1012. The I/O component 1004 may also include an output component, such as a display 1002 and a cursor control 1008 (such as a keyboard, keypad, mouse, etc.). The display 1002 may be configured to present a login page for logging into a user account or a checkout page for purchasing an item from a merchant. An optional audio input/output component 1006 may also be included to allow a user to use voice for inputting information by converting audio signals. The audio I/O component 1006 may allow the user to hear audio. A transceiver or network interface 1020 transmits and receives signals between the computer system 1000 and other devices, such as another user device, a merchant server, or a service provider server via a network 1022, such as network 160 of FIG. 1. In one embodiment, the transmission is wireless, although other transmission mediums and methods may also be suitable. A processor 1014, which can be a micro-controller, digital signal processor (DSP), or other processing component, processes these various signals, such as for display on the computer system 1000 or transmission to other devices via a communication link 1024. The processor 1014 may also control transmission of information, such as cookies or IP addresses, to other devices.

The components of the computer system 1000 also include a system memory component 1010 (e.g., RAM), a static storage component 1016 (e.g., ROM), and/or a disk drive 1018 (e.g., a solid-state drive, a hard drive). The computer system 1000 performs specific operations by the processor 1014 and other components by executing one or more sequences of instructions contained in the system memory component 1010. For example, the processor 1014 can perform the cryptocurrency transaction functionalities described herein according to the processes 700, 800, and 900.

Logic may be encoded in a computer readable medium, which may refer to any medium that participates in providing instructions to the processor 1014 for execution. Such a medium may take many forms, including but not limited to, non-volatile media, volatile media, and transmission media. In various implementations, non-volatile media includes optical or magnetic disks, volatile media includes dynamic memory, such as the system memory component 1010, and transmission media includes coaxial cables, copper wire, and fiber optics, including wires that comprise the bus 1012. In one embodiment, the logic is encoded in non-transitory computer readable medium. In one example, transmission media may take the form of acoustic or light waves, such as those generated during radio wave, optical, and infrared data communications.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by the computer system 1000. In various other embodiments of the present disclosure, a plurality of computer systems 1000 coupled by the communication link 1024 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The various features and steps described herein may be implemented as systems comprising one or more memories storing various information described herein and one or more processors coupled to the one or more memories and a network, wherein the one or more processors are operable to perform steps as described herein, as non-transitory machine-readable medium comprising a plurality of machine-readable instructions which, when executed by one or more processors, are adapted to cause the one or more processors to perform a method comprising steps described herein, and methods performed by one or more devices, such as a hardware processor, user device, server, and other devices described herein.

What is claimed is:

1. A system, comprising:
a non-transitory memory; and
one or more hardware processors coupled with the non-transitory memory and configured to read instructions from the non-transitory memory to cause the system to perform operations comprising:
broadcasting a first cryptocurrency transaction record to a cryptocurrency network, the first cryptocurrency transaction record targeting a subset of computer nodes from a plurality of computer nodes associated with the cryptocurrency network;
subsequent to the broadcasting, detecting a transaction block that includes the first cryptocurrency transaction record on a blockchain associated with the cryptocurrency network;
accessing a second cryptocurrency transaction record from the transaction block;
extracting data corresponding to a Layer Two invoice from the second cryptocurrency transaction record; and
transferring a secondary transaction fee to a particular computer node from the subset of computer nodes over a Layer Two cryptocurrency computer network based on the Layer Two invoice.

2. The system of claim 1, wherein the second cryptocurrency transaction record corresponds to a Coinbase transaction of the transaction block.

3. The system of claim 1, wherein the operations further comprise:
receiving, from a user device, a transaction request for processing a cryptocurrency transaction; and
generating the first cryptocurrency transaction record for the cryptocurrency transaction, wherein the first cryptocurrency transaction record comprises a transaction output that indicates an address corresponding to the system.

4. The system of claim 1, wherein the operations further comprise:
selecting, from the plurality of computer nodes associated with a cryptocurrency network, the subset of computer nodes based on a set of criteria.

5. The system of claim 1, wherein the data corresponding to the Layer Two invoice stored in the second cryptocurrency transaction record is encrypted, and wherein the operations further comprise:
determining, from the subset of the computer nodes, a particular computer node associated with the Layer Two invoice based on a particular key usable to decrypt the data corresponding to the Layer Two invoice.

6. The system of claim 5, wherein the data comprises a hashed value, and wherein the operations further comprise:
accessing the Layer Two invoice using a lookup table based on the hashed value.

7. The system of claim 5, wherein the determining the particular computer node associated with the Layer Two invoice comprises:
performing a decryption process on the data using a plurality of encryption keys associated with the subset of computer nodes; and
determining that the data is decrypted using the particular key from the plurality of encryption keys.

8. A method, comprising:
subsequent to broadcasting a first transaction record to a blockchain network, detecting, by a computer system, that a transaction block that includes the first transaction record has been added to a blockchain associated with the blockchain network, the first transaction record targeting a subset of computer nodes from a plurality of computer nodes associated with the blockchain network;
extracting, from a second transaction record included in the transaction block, encrypted data corresponding to a digital invoice;
identifying, by the computer system and from the subset of computer nodes, a particular computer node that processed the first cryptocurrency transaction record based on an encryption key usable to decrypt the encrypted data; and
transferring, by the computer system, a secondary transaction fee to the particular computer node over a Layer Two cryptocurrency computer network based on the digital invoice.

9. The method of claim 8, further comprising generating the first transaction record for a cryptocurrency transaction.

10. The method of claim 9, further comprising:
receiving, via a user interface provided on a device, user inputs related to the cryptocurrency transaction, wherein the first transaction record is generated based on the user inputs.

11. The method of claim 9, further comprising:
determining a code usable to indicate that the first transaction record targets the subset of computer nodes; and
incorporating the code into the first transaction record.

12. The method of claim 8, further comprising:
generating a plurality of pairs of encryption keys for the subset of computer nodes, wherein each pair of encryption keys in the plurality of pairs of encryption keys comprises a private key and a public key; and
distributing corresponding public keys in the plurality of pairs of encryption keys to the subset of computer nodes.

13. The method of claim 12, further comprising attempting to decrypt the encrypted data using private keys from the plurality of pairs of encryption keys.

14. The method of claim 8, wherein the first transaction record is generated for a cryptocurrency transaction, and wherein the method further comprises:
selecting, from the plurality of computer nodes, the subset of computer nodes for processing the cryptocurrency transaction based on attributes associated with the cryptocurrency transaction.

15. A non-transitory machine-readable medium having stored thereon machine-readable instructions executable to cause a machine to perform operations comprising:
broadcasting a first transaction record corresponding to a cryptocurrency transaction to a blockchain network, the first transaction record targeting a subset of computer nodes from a plurality of computer nodes associated with the blockchain network;
subsequent to the broadcasting, detecting that a transaction block that includes the first transaction record has been added to a blockchain associated with the blockchain network;
extracting, from a second transaction record included in the transaction block, encrypted data corresponding to a digital invoice;
identifying, from the subset of computer nodes, a particular computer node that processed the first cryptocurrency transaction record based on the encrypted data; and
transferring, by the computer system, a secondary transaction fee to the particular computer node over a Layer Two cryptocurrency computer network based on the digital invoice.

16. The non-transitory machine-readable medium of claim 15, wherein the second cryptocurrency transaction record corresponds to a Coinbase transaction of the transaction block.

17. The non-transitory machine-readable medium of claim 15, wherein the operations further comprise:
receiving, from a user device, a transaction request for processing the cryptocurrency transaction; and
generating the first transaction record for the cryptocurrency transaction based on the transaction request, wherein the first transaction record comprises a first transaction output that specifies a recipient digital wallet in the cryptocurrency transaction.

18. The non-transitory machine-readable medium of claim 17, wherein the operations further comprise:
distributing a code for the cryptocurrency transaction to the subset of computer nodes; and
incorporating the code into a second transaction output of the first transaction record.

19. The non-transitory machine-readable medium of claim 15, wherein the operations further comprise:
selecting, from the plurality of computer nodes associated with a cryptocurrency network, the subset of computer nodes based on a set of criteria.

20. The non-transitory machine-readable medium of claim 15, wherein the operations further comprise:
performing a decryption process on the data using a plurality of encryption keys associated with the subset of computer nodes; and
determining that the data is decrypted using a particular key from the plurality of encryption keys, wherein the particular computer node is identified based on the particular key.
